(19) United States
(12) Patent Application Publication
(10) Pub. No.: US 2004/0061797 A1
(43) Pub. Date: Apr. 1, 2004

(54) Digital camera

(75) Inventors: Kazusei Takahashi, Sakai-Shi (JP); Kenji Nakamura, Takatsuki-Shi (JP); Masahito Niikawa, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: Minolta Co., Ltd.

(21) Appl. No.: 10/334,378

(22) Filed: Dec. 30, 2002

(30) Foreign Application Priority Data
Sep. 30, 2002 (JP) P2002-286086

(51) Int. Cl. H04N 5/222

(52) U.S. Cl. 348/333.01

(57) ABSTRACT

The present invention provides a digital camera which performs optimum image display on a display device such as a digital TV. When a display device 2 is connected to a digital camera 1, a detection circuit 49a detects display resolution of the display device 2 and changes a method of reading a CCD image capturing device 20 in accordance with the display resolution. An image obtained from the CCD image capturing device 20 is processed by a resolution converting unit 26, thereby generating an image for display adapted to the display resolution. At the time of image reproduction, the display resolution of the display device 2 is changed according to the size of a taken image to be reproduced, thereby realizing high-definition reproduction and display on the display device 2.

This application is based on application No. 2002-286086 filed in Japan, the contents of which are hereby incorporated by reference.

### BACKGROUND OF THE INVENTION

1. Field of the Invention

The present invention relates to an image display technique of performing a process of displaying an image in a digital camera.

2. Description of the Background Art

Many of commercially available digital cameras are provided with a connection terminal for connecting an external display device. A digital camera of this kind is constructed so that an image displayed on an electronic viewfinder (EVF) or a liquid crystal display can be also displayed on an external display device and a video signal (for example, an NTSC signal) is outputted from the connection terminal to the external display device.

In the market, a number of digital cameras each having the number of pixels of 3,000,000 or more are also available. However, when an external display device is connected to such a digital camera having a number of pixels, an image cannot be displayed with high definition by utilizing the large number of pixels.

Consequently, in association with widespread use of a digital broadcast compatible television receiver (hereinafter, referred to as “digital TV”) capable of displaying a high-precision image in recent years such as the digital still camera GC-X3 of Victor Co. of Japan or as disclosed in Japanese Patent Application Laid-Open No. 2000-138889, a digital camera connected to a digital TV and capable of displaying an image by utilizing the large number of pixels of the digital camera onto the digital TV is appearing.

However, the conventional digital TV compatible digital camera has the following problems.

First, at the time of displaying a live view in an image-taking standby mode, an image is converted to a conventional video format and the resultant image is outputted from the digital camera to the digital TV. Consequently, there is still a problem such that high-definition image display utilizing the high resolution of the digital TV cannot be performed.

In the case of reproducing and displaying an image obtained by image capturing, when a digital TV is connected, a size-reducing process or the like is performed on the captured image data, and the resultant is reproduced and displayed. Consequently, there is a problem such that the processing efficiency at the time of reproduction and display is low and an image is not immediately reproduced and displayed in response to a reproduction instruction.

In short, the conventional digital camera compatible with a digital TV has a problem such that it cannot optimally display an image on a digital TV in accordance with processing conditions of the digital camera, or the like.

### SUMMARY OF THE INVENTION

The present invention is directed to a digital camera.

According to an aspect of the present invention, a digital camera includes: a detector for detecting a display condition of a display unit for performing display; a controller for controlling the digital camera; and a control changing unit for changing a control operation performed by the controller in accordance with a detection signal of the detector.

With the configuration, the control operation in the digital camera is changed according to the display condition of the display unit.

According to another aspect of the present invention, there is provided a digital camera which can be connected to an external display unit, including: a detector for detecting display resolution of the external display unit for performing display; a data processor for generating image data to be displayed on the external display unit; and a process changing unit for changing a process to be performed by the data processor in accordance with display resolution of the external display unit detected by the detector.

With the configuration, image data adapted to the display resolution of the external display unit such as a digital TV can be generated and an image adapted to the display resolution of the external display unit can be displayed.

The present invention is also directed to an image display system.

According to an aspect of the present invention, there is provided an image display system in which a digital camera and a display unit are connected to each other, wherein the display unit has predetermined display resolution and displays an image inputted from the digital camera, and the digital camera includes: a detector for detecting display resolution of the display unit; a data processor for generating image data to be displayed on the display unit; and a process changing unit for changing a process to be performed by the data processor on the basis of display resolution of the display unit detected by the detector.

With the configuration, an image adapted to the display resolution of the display unit is generated in the digital camera and an optimum image is always displayed on the display unit.

As described above, an object of the present invention is to provide a technique capable of displaying an optimum image on a display unit such as a digital TV by means of a digital camera.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing the configuration example of an image-taking system;

FIG. 2 is a front view showing the appearance configuration of the digital camera;

FIG. 3 is a top view showing the appearance configuration of the digital camera;

FIG. 4 is a rear view showing the appearance configuration of the digital camera;

FIG. 5 is a block diagram showing the internal configuration of the digital camera;

FIG. 6 is a diagram for describing CCD reading modes;

FIG. 7 is a flowchart showing a processing sequence of a digital camera in an image-taking mode;

FIG. 8 is a flowchart showing the processing sequence of the digital camera in the image-taking mode;

FIG. 9 is a flowchart showing the processing sequence of the digital camera in the image-taking mode;

FIG. 10 is a flowchart showing the processing sequence of the digital camera in the image-taking mode;

FIG. 11 is a flowchart showing the processing sequence of the digital camera in the image-taking mode;

FIG. 12 is a diagram showing the structure of an image file;

FIG. 13 is a flowchart showing the processing sequence of the digital camera in a reproduction mode;

FIG. 14 is a flowchart showing the processing sequence of the digital camera in the reproduction mode;

FIG. 15 is a flowchart showing the processing sequence of the digital camera in the reproduction mode;

FIG. 16 is a flowchart showing the processing sequence of the digital camera in the reproduction mode;

FIG. 17 is a flowchart showing processes in the reproduction mode in a second embodiment;

FIG. 18 is a flowchart showing processes in the reproduction mode in the second embodiment;

FIG. 19 is a flowchart showing processes in the reproduction mode in the second embodiment;

FIG. 20 is a flowchart showing processes in the reproduction mode in the second embodiment;

FIG. 21 is a flowchart showing a linking operation in the image-taking system in the case of changing the video format of a display device from a digital camera;

FIG. 22 is a flowchart showing a processing sequence in the image-taking mode in a third embodiment;

FIG. 23 is a flowchart showing a processing sequence in the image-taking mode in the third embodiment;

FIG. 24 is a flowchart showing a processing sequence in the image-taking mode in the third embodiment;

FIG. 25 is a diagram showing a video format selecting screen;

FIG. 26 is a diagram showing a moving image size selecting screen;

FIG. 27 is a flowchart showing the operation in a moving image recording mode;

FIG. 28 is a flowchart showing a processing sequence in the reproduction mode in the third embodiment;

FIG. 29 is a flowchart showing a processing sequence in the reproduction mode in the third embodiment;

FIG. 30 is a flowchart showing a processing sequence in the reproduction mode in the third embodiment; and

FIG. 31 is a flowchart showing the operation in a setting mode.

### DESCRIPTION OF THE PREFERRED EMBODIMENTS

Hereinafter, embodiments of the present invention will be described in detail with reference to the drawings.

1. First Embodiment

1-1. Image-Taking System

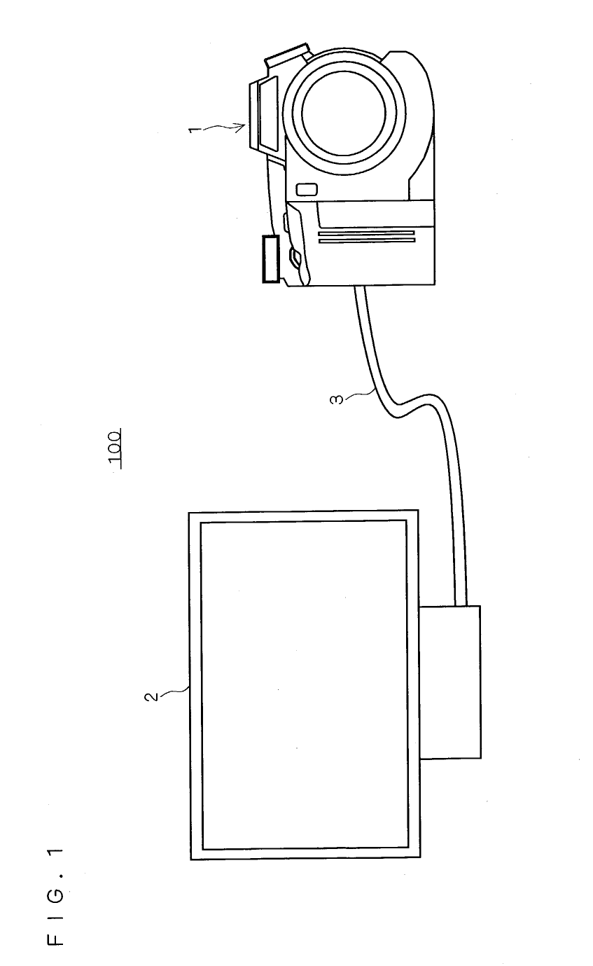

FIG. 1 is a view showing a configuration example of an image-taking system 100 according to a first embodiment. As shown in FIG. 1, the image-taking system 100 has a configuration in which a digital camera 1 and a display device 2 constructed by a digital TV or the like and capable of displaying a high-definition image are connected to each other via a cable 3 for data transmission. An image captured by the digital camera 1 can be displayed on the display device 2.

The display device 2 can change its video format (display resolution) and performs an image displaying operation by selecting and setting one of five kinds of video image formats of, for example, 525i, 525p, 750p, 1125i and 1125p. For example, in the case where the video format of 525i or 525p is selected, the display resolution in the display device 2 is 720 pixels horizontally by 480 pixels vertically.

When the display device 2 is connected to the digital camera 1, the display device 2 transmits the video format to the digital camera 1.

1-2. Configuration of Digital Camera

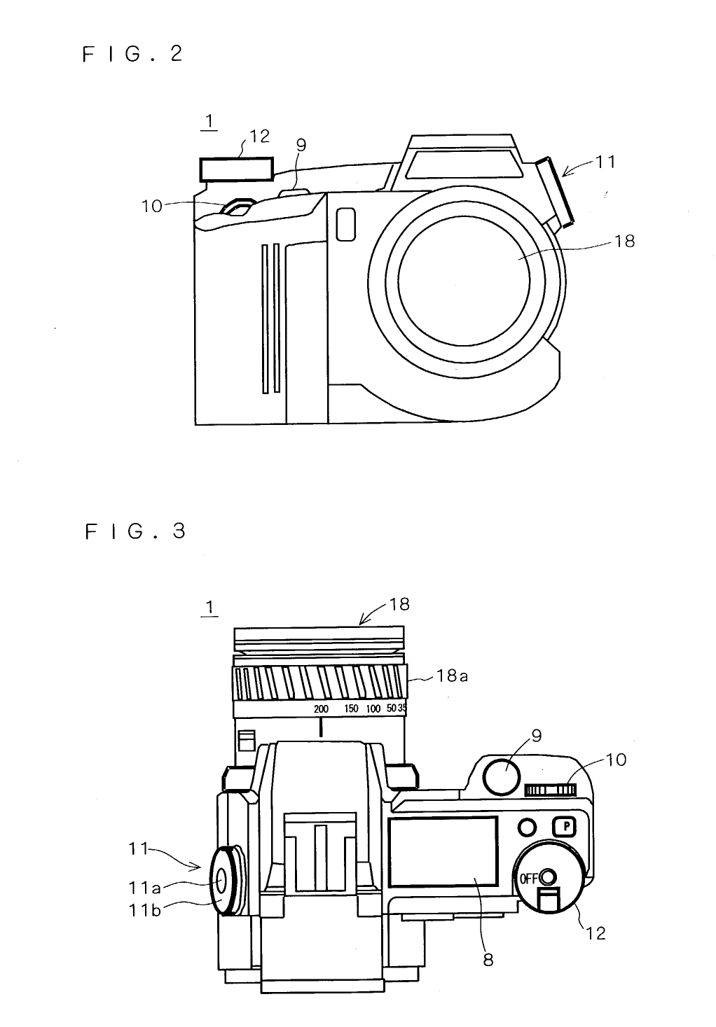

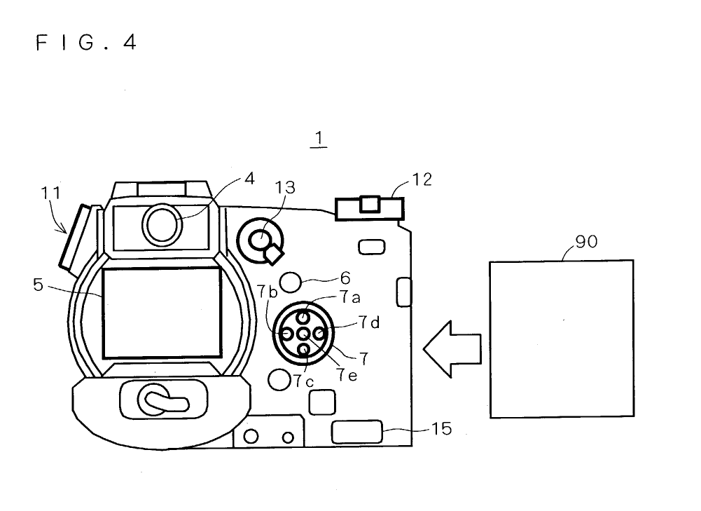

The configuration of the digital camera 1 will now be described. FIGS. 2, 3 and 4 are diagrams each showing the appearance configuration of the digital camera 1. FIG. 2 is a front view, FIG. 3 is a top view, and FIG. 4 is a rear view. The views are not always according to triangulation but a principal objective is to illustrate the appearance of the digital camera 1.

A taking lens 18 is provided on the front face side of the digital camera 1. The taking lens 18 has a zooming function. By turning a zoom ring 18a by a manual operation, the magnification can be changed.

A shutter button (release button) 9 is provided in the upper part of a grip 1a of the digital camera 1. The shutter button 9 is a switch of two levels capable of discriminating a touched state (state S1) and a fully depressed state (state S2) by the user from each other. When an auto-focus (AF) mode is set, an auto-focus control is started in the state S1, and an image-taking operation for capturing an image to be recorded is started in the state S2.

In the upper part of the grip 1a, a dial operating unit 10 which can be turned in two directions of forward and rearward sides (that is, in the right and left directions) is provided. The user can easily perform the operation of turning the dial operating unit 10 while holding the digital camera 1.

In the top face of the digital camera 1, a mode switching dial 12 for switching and setting “image-taking mode”, “reproduction mode” and “setting mode” is provided. The image-taking mode is a mode of capturing an image of a subject and generating image data. As the image-taking mode, either a still image recording mode for recording a still image or a moving image recording mode for recording a moving image can be selected. The reproduction mode is a mode of reproducing image data recorded in a memory card 90 and displaying the reproduced image data onto a liquid crystal display (hereinafter, abbreviated as LCD) 5 or the like provided on the rear face side of the digital camera 1.

On the rear face of the digital camera 1, an electronic viewfinder (hereinafter, abbreviated as EVF) 4 and the LCD 5 for performing live view display in an image-taking standby mode before image-taking operation, after view display after the image-taking operation, reproduction and display of a recorded image, and the like are provided. In each of the EVF 4 and LCD 5, a color image is displayed. In the following description, for example, each of the EVF 4 and LCD 5 has 320 pixels in the horizontal direction and 240 pixels in the vertical direction.

On the rear face of the digital camera 1, a menu button 6 is provided. For example, when the menu button 6 is depressed in the image-taking mode, various menu screens for setting various image-taking conditions are displayed on the LCD 5. On the rear face of the digital camera 1, a control button 7 is provided, which is constructed by cross cursor buttons 7a to 7d for moving a display cursor on the LCD 5 in four ways and an enter button 7e provided in the center of the cross cursor buttons. By using the menu button 6 and the control button 7, an operation of setting various image-taking parameters is performed. The state of setting of the various image-taking parameters is displayed on a data panel 8 disposed on the top face side of the digital camera 1. On the rear face of the digital camera 1, a switch button 13 for switching display between the live view display on the EVF 4 or the live view display on the LCD 5 is also provided.

In the lower part of the rear face of the digital camera 1, a connection terminal 15 which is a so-called D terminal is provided for outputting an image for display to the display device 2. The cable 3 shown in FIG. 1 is connected to the connection terminal 15.

Further, on a side face of the digital camera 1, a function operating unit 11 for performing an operation regarding a setting state of the digital camera 1 is provided. The function operating unit 11 is constructed by a function button 11a provided in the center and a function dial 11b provided so as to be turnable. On a side face of the digital camera 1, an insertion port of the memory card 90 as a detachable recording medium is provided. Image data obtained by the image-taking operation is recorded on the memory card 90 which is set in the insertion port.

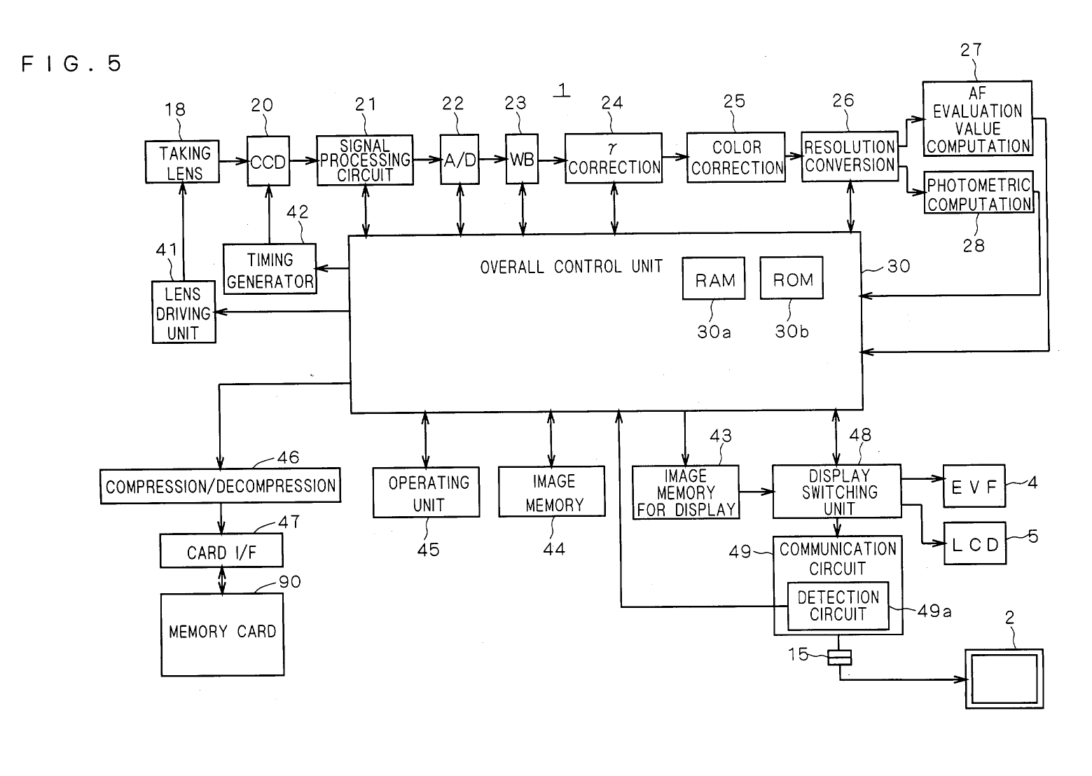

The internal configuration of the digital camera 1 will now be described. FIG. 5 is a block diagram showing internal functions of the digital camera 1.

The taking lens 18 is driven by a lens driving unit 41 to change the focus state of an image formed on a CCD image capturing device 20. When auto-focus (AF) is set, a lens driving amount of the taking lens 18 is automatically determined from an image by an overall control unit 30, and the taking lens 18 is driven on the basis of the lens driving amount. In contrast, when manual-focus (MF) is set, the lens driving amount is determined according to the operation amount of the control button 7 by the user, and the taking lens 18 is driven on the basis of the lens driving amount.

The CCD image capturing device 20 has a function of capturing an image of a subject and generating an electronic image signal and has, for example, 2,560 pixels in the horizontal direction and 1,920 pixels in the vertical direction. The CCD image capturing device 20 photoelectrically converts an optical image of the subject formed by the taking lens 18 to image signals (signals of a signal train of pixel signals received by pixels) of color components of R (red), G (green) and B (blue) on a pixel unit basis and outputs the image signal.

A timing generator 42 generates various timing pulses for controlling the driving of the CCD image capturing device 20. The timing generator 42 sets, as a CCD reading mode, one of a full-frame mode, a double-speed mode, an octuple-speed mode and an AF mode on the basis of an instruction from the overall control unit 30 and accordingly drives the CCD image capturing device 20.

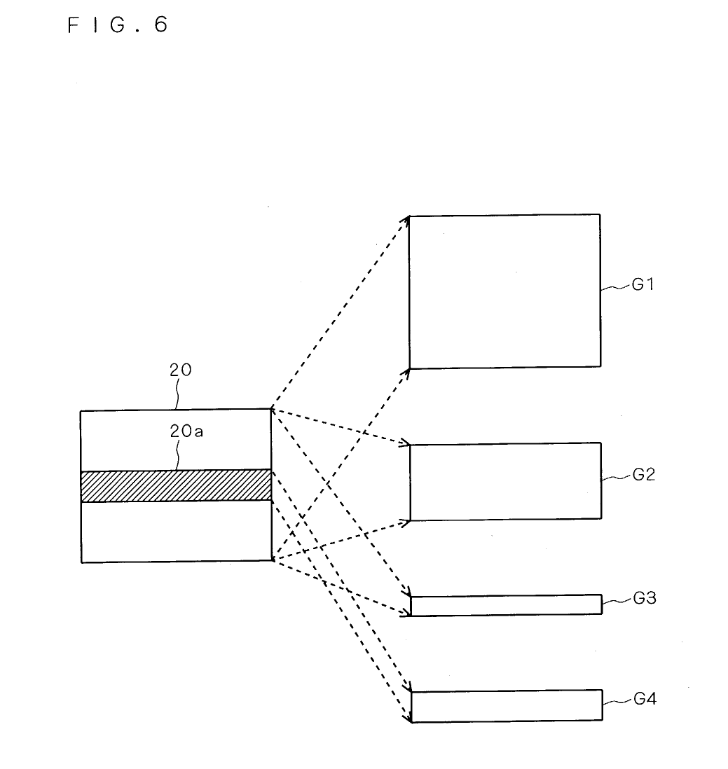

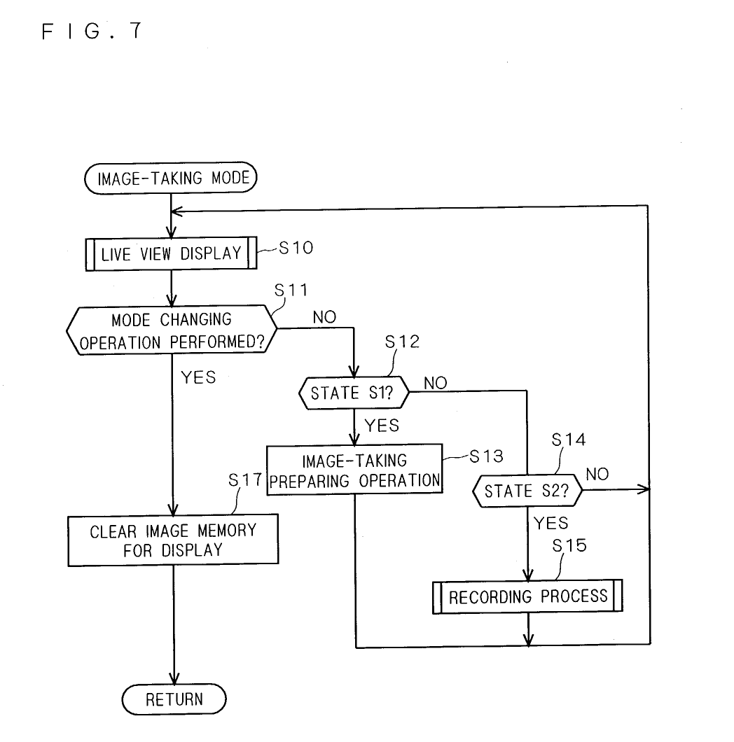

FIG. 6 is a diagram for describing the CCD reading modes. In the case where the timing generator 42 drives the CCD image capturing device 20 in the full-frame mode, signals of all of pixels of 2,560 pixels horizontally by 1,920 pixels vertically are outputted from the CCD image capturing device 20 and an image G1 having pixels 2,560 horizontally by 1,920 pixels vertically is outputted. In the case of driving the CCD image capturing device 20 in the double-speed mode, an image is outputted from the CCD image capturing device 20 while reducing the number of pixels to the half in the vertical direction (concretely, while outputting two lines out of four lines), thereby outputting an image G2 having 2,560 pixels in the horizontal direction and 960 pixels in the vertical direction. In the case of driving the CCD image capturing device 20 in the octuple-speed mode, an image is outputted from the CCD image capturing device 20 while reducing the pixels to 1/8 in the vertical direction, thereby outputting an image G3 having 2,560 pixels in the horizontal direction and 240 pixels in the vertical direction. Further, in the case of driving the CCD image capturing device 20 in the AF mode, an image of a portion corresponding to an area 20a for AF (a hatched area in FIG. 6) specified in the center portion of the CCD image capturing device 20 is outputted, thereby outputting an image G4 for AF having 2,560 pixels in the horizontal direction and 272 pixels in the vertical direction.

In the full-frame mode, a reading frame rate from the CCD image capturing device 20 is 3.75 fps. In the modes other than the full-frame mode, the data amount per frame is reduced, so that the frame rate can be increased. In the double speed mode, the frame rate is 7.49 fps. In the octuple-speed mode, the frame rate is 29.97 fps.

An image signal outputted from the CCD image capturing device 20 in accordance with the reading mode is supplied to the signal processing circuit 21. The image signal (analog signal) is subjected to a predetermined analog signal process in the signal processing circuit 21. The signal processing circuit 21 has a correlated double sampling (CDS) circuit and an auto gain control (AGC) circuit, performs a process of reducing noise in the image signal by the CDS circuit, and adjusts the gain by the AGC circuit, thereby adjusting the level of the image signal.

An A/D converter 22 converts each of pixels signals of the image signal to a 12-bit digital signal. The A/D converter 22 converts each pixel signal (analog signal) to a 12-bit digital signal synchronously with a clock for A/D conversion supplied from the overall control unit 30.

A WB (White Balance) circuit 23 shifts the level of each of color components of R, G and B. The WB circuit 23 shifts the level of each of the color components of R, G and B by using a level shifting table stored in the overall control unit 30. The parameter (gradient of the characteristic) of each color component in the level shifting table is automatically or manually set by the overall control unit 30 every image taken. A γ correction circuit 24 corrects the tone of pixel data.

A color correction circuit 25 performs color correction on image data inputted from the γ correction circuit 24 on the basis of a parameter regarding the color correction which is set by the user, and converts color information expressed in the RGB color space into color information expressed in the YCrCb color space. By the conversion of the colorimetric system, a luminance component value Y is obtained with respect to all of pixels.

A resolution converting unit 26 performs predetermined resolution conversion on image data obtained from the CCD image capturing device 20. For example, in the case of performing live view display on the EVF 4 or LCD 5, the resolution converting unit 26 generates image data having 320 pixels in the horizontal direction and 240 pixels in the vertical direction adapted to the number of display pixels of the EVF 4 or LCD 5. In the case where the display device 2 is connected to the digital camera 1, the resolution converting unit 26 generates image data having the number of pixels adapted to the resolution of the display device 2.

An AF evaluation value computing unit 27 performs an evaluation value computing operation for performing an auto-focus control of a contrast method (hill-climbing method) on the basis of the image G4 obtained in the AF mode at the time of AF. For example, the absolute vale of the difference between two pixels neighboring in the horizontal direction is obtained and the sum of difference absolute values in the image G4 is calculated as an evaluation value for AF. The evaluation value for AF calculated by the AF evaluation value computing unit 27 is outputted to the overall control unit 30 where the AF control is performed.

A photometric computing unit 28 divides image data for live view outputted from the resolution converting unit 26 into a plurality of blocks and calculates the evaluation value for AE on the basis of a representative luminance value of each block. The evaluation value for AE calculated by the photometric computing unit 28 is outputted to the overall control unit 30 and used for automatic exposure control in the overall control unit 30.

A display image memory 43 is a memory for storing image data to be displayed on the EVF 4, LCD 5 or display device 2. By storing an image in the image memory 43 for display, the image can be displayed on the EVF 4, LCD 5 or display device 2.

A display switching unit 48 switches the output destination of the image stored in the image memory 43 for display at the time of the live view display, after view display or reproduction display. When the display device 2 is connected to the connection terminal 15, the image to be displayed is outputted to the display device 2. When the display device 2 is not connected to the connection terminal 15, the image to be displayed is outputted to the EVF 4 or LCD 5 provided on the rear face of the digital camera 1.

A communication circuit 49 is a circuit for performing data communication with the display device 2 in the case where the display device 2 is connected to the connection terminal 15. The image to be displayed is transmitted to the display device 2 by a data transmitting function of the communication circuit 49. The communication circuit 49 has a detection circuit 49a. The detection circuit 49a detects the connection state of the display device 2 and also the video format (display resolution) of the display device 2 on the basis of a signal received from the display device 2. The video format (display resolution) of the display device 2 detected by the detection circuit 49a is transmitted to the overall control unit 30.

The image memory 44 is a memory for temporarily storing image data obtained by the CCD image capturing device 20 by the image-taking operation performed in response to the state S2 and subjected to various image processes. The image memory 44 has a storage capacity of at least one frame. When the after view display is performed on an image after the image-taking operation, image data for after view is generated from the image data stored in the image memory 44, and image display is performed for checking a captured image. When a recording instruction is given from the user, an image file including a captured image and a thumbnail image is generated from the image data stored in the image memory 44 and transferred to the memory card 90, thereby recording the image file.

A card interface (I/F) 47 is an interface for writing/reading image data to/from the memory card 90 inserted to the insertion port in the side face of the digital camera 1. At the time of writing/reading the image file to/from the memory card 90, a compressing/decompressing process is performed on the image data by a compressing/decompressing unit 46, for example, in the JPEG method. In the memory card 90, not only the image file but also a control program can be recorded. For example, a control program recorded in a recording medium such as the memory card 90 can be loaded into a RAM 30a or a ROM 30b in the overall control unit 30 via the card I/F 47. By executing the program in the overall control unit 30, various functions to be described later are realized.

An operating unit 45 includes the menu button 6, control button 7, shutter button 9, function operating unit 11, mode switching dial 12 and switch button 13, and is used when the user performs an operation of changing the setting state of the digital camera 1, an image-taking operation, a reproducing operation and the like.

The overall control unit 30 is constructed by a microcomputer having therein the RAM 30a and the ROM 30b. When the microcomputer executes a predetermined program stored in the ROM 30b, the overall control unit 30 functions as a control part for controlling the above-described components in a centralized manner. The ROM 30b takes the form of an electrically erasable nonvolatile memory. For example, a program to be stored in the memory card 90 can be installed into the ROM 30b.

1-3. Process in Image-Taking Mode

The process in the image-taking mode in the digital camera 1 of the above-described configuration will now be described. FIGS. 7 to 11 are flowcharts showing the processing sequence of the digital camera 1 in the image-taking mode.

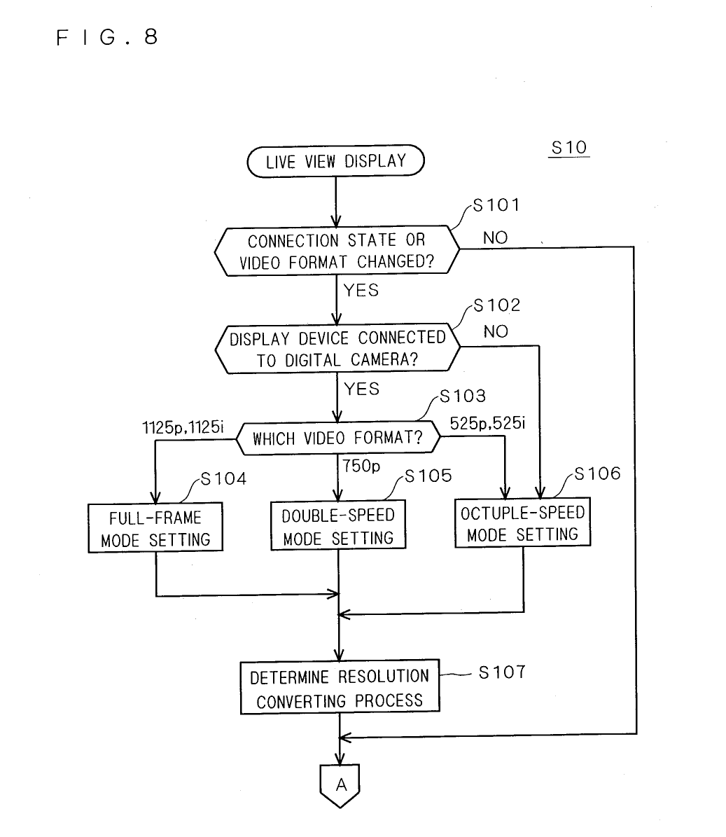

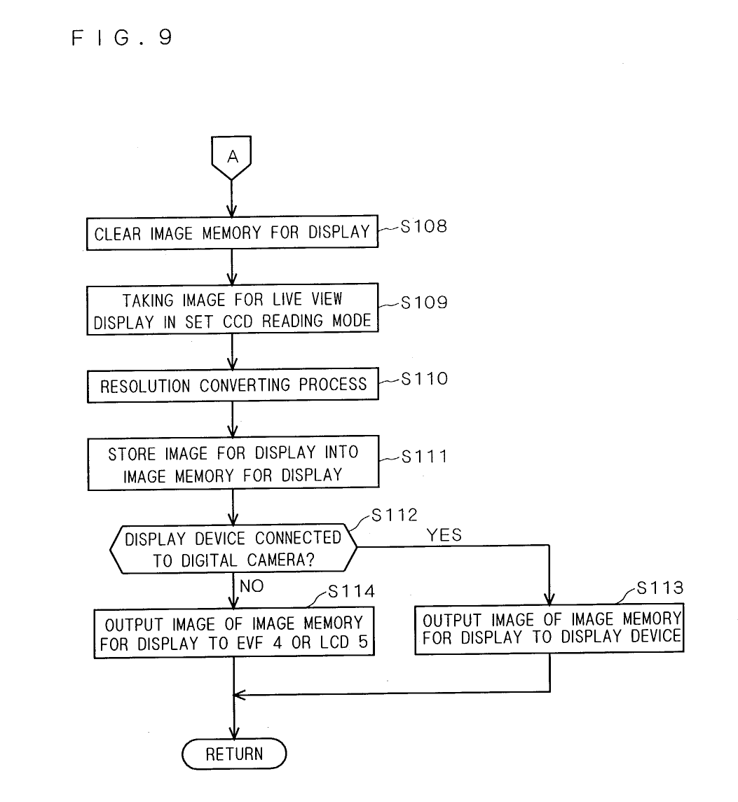

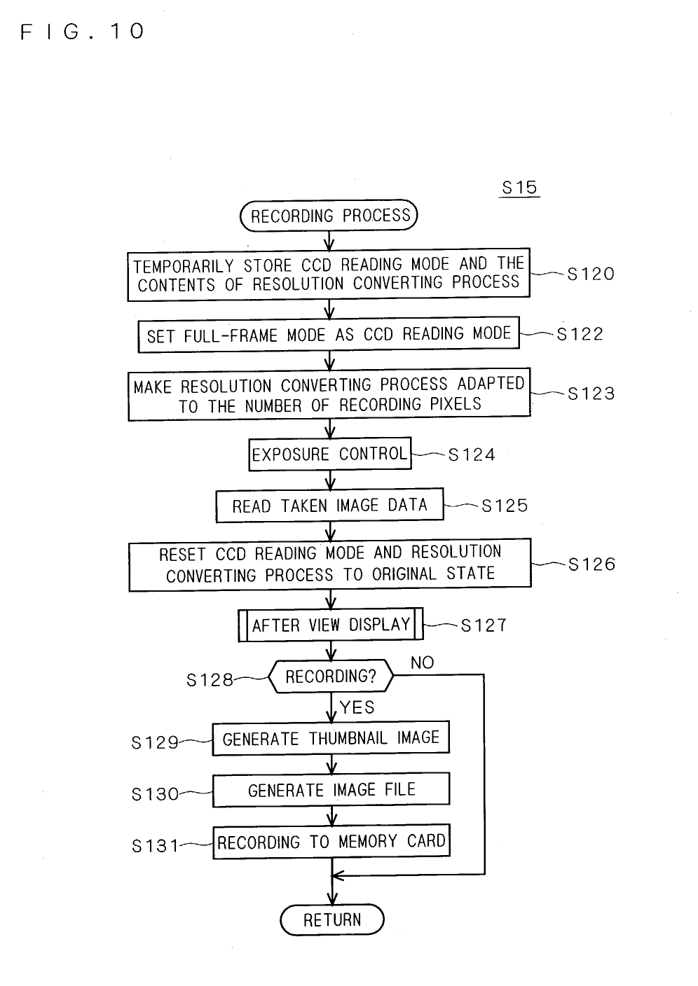

First, when the digital camera 1 enters the image-taking mode, a process for live view display (step S10) is performed in the digital camera 1. FIGS. 8 and 9 are flowcharts showing the details of the live view display process. In the live view display process, the overall control unit 30 detects the presence or absence of a change in the connection state of the display device 2 or in the video format (step S101). When there is a change in the connection state of the display device 2 to the digital camera 1 or the video format of the display device 2, the process advances to step S102. If there is no change, the process advances to step S108. In the case where step S101 is executed only after the digital camera 1 enters the image-taking mode, the process always advances to step S102.

In step S102, whether the display device 2 is connected to the digital camera 1 or not is determined. If YES, the process advances to step S103. If NO, the process advances to step S106.

When the display device 2 is connected to the digital camera 1, the overall control unit 30 checks the video format of the display device 2 (step S103). When the video format of the display device 2 is 1125i or 1125p, the CCD reading mode is set to the full-frame mode (step S104). When the video format of the display device 2 is 750p, the CCD reading mode is set to the double-speed mode (step S105). When the video format of the display device 2 is 525i or 525p, the CCD reading mode is set to the octuple-speed mode (step S106). Also in the case where the display device 2 is not connected to the digital camera 1, the CCD reading mode is set to the octuple-speed mode in step S106.

In step S107, the overall control unit 30 determines a process to be performed in the resolution converting unit 26.

When the full-frame mode is set as the CCD reading mode, image data of 1,960 lines is outputted from the CCD image capturing device 20. 1,920 lines out of the 1,960 lines are used for display. Consequently, in the resolution converting process, a process for converting an image having 2,560 pixels in the horizontal direction and 1,920 pixels in the vertical direction to an image having 1,440 pixels in the horizontal direction and 1,080 pixels in the vertical direction is determined.

When the double-speed mode is set as the CCD reading mode, image data of 980 lines is outputted from the CCD image capturing device 20, and image data of 960 lines out of the 980 lines is used for display. Consequently, in the resolution converting process, a process for converting an image having 2,560 pixels in the horizontal direction and 960 pixels in the vertical direction to an image having 960 pixels in the horizontal direction and 720 pixels in the vertical direction is determined.

When the display device 2 is connected and the octuple-speed mode is set as the CCD reading mode, image data of 245 lines is outputted from the CCD image capturing device 20 and, image data of 240 lines out of the 245 lines is used for display. Consequently, to convert an image of 2,560 lines in the horizontal direction and 240 lines in the vertical direction to an image having 640 pixels in the horizontal direction and 480 pixels in the vertical direction in the resolution converting process, a resolution converting process (interpolating process) for enlarging the image twice in the vertical direction is determined, and a resolution converting process for reducing the image to ¼ in the horizontal direction is determined.

Further, also in the case where the display device 2 is not connected and the octuple-speed mode is set as the CCD reading mode, image data of 245 lines is outputted from the CCD image capturing device 20 and 240 lines out of the 245 lines are used for display. Consequently, in the resolution converting process, in order to convert an image of 2,560 pixels in the horizontal direction and 240 pixels in the vertical direction to an image having 320 pixels in the horizontal direction and 240 pixels in the vertical direction, a resolution converting process for reducing the image to ⅛ only in the horizontal direction is determined.

The resolution converting process determined as described above is instructed from the overall control unit 30 to the resolution converting unit 26.

After that, the process advances to step S108 in FIG. 9 where the image memory 43 for display is cleared.

In the digital camera 1, an image-taking operation for the live view display is performed in the CCD reading mode which is set in any of steps S104 to S106 (step S109). The image data obtained here is supplied to the resolution converting unit 26 and subjected to the resolution converting process determined in step S107.

In short, when the video format is 1125p or 1125i, an image is obtained in the full frame mode, an image for display having 1,440 pixels in the horizontal direction and 1,080 pixels in the vertical direction is generated, and the frame rate is 3.75 fps. When the video format is 750p, an image is obtained in the double-speed mode, an image for display having 960 pixels in the horizontal direction and 720 pixels in the vertical direction is generated, and the frame rate is 7.49 fps. When the video format is 525p or 525i, an image is obtained in the octuple-speed mode, an image for display having 640 pixels in the horizontal direction and 480 pixels in the vertical direction is obtained, and the frame rate is 29.97 fps. Further, when the display device 2 is not connected, an image is obtained in the octuple-speed mode, an image for display having 320 pixels in the horizontal direction and 240 pixels in the vertical direction is generated, and the frame rate is 29.97 fps.

The image for display obtained in such a manner is stored in the image memory 43 for display (step S111). The image for display generated by the resolution conversion becomes an image to be displayed (live view image) on the EVF 4, LCD 5 or display device 2.

Whether the display device 2 is connected to the digital camera 1 or not is determined (step S112). If the display device 2 is not connected, the image for display stored in the image memory 43 for display is outputted to the EVF 4 or LCD 5 and live view display is performed on the display device provided for the digital camera 1 at the frame rate of 29.97 fps (step S114).

If the display device 2 is connected, the image for display stored in the image memory 43 for display is outputted to the display device 2, and live view display is performed on the display device 2 provided outside of the digital camera 1 (step S113). At this time, an image displayed on the display device 2 is an image generated according to the video format of the display device 2 and adapted to the resolution of the display device 2. Therefore, high-definition live-view display can be performed on the display device 2. The higher the display resolution of the display device 2 is, the lower the frame rate is.

Referring again to the flowchart of FIG. 7, after the live view display (step S10) is performed, the overall control unit 30 determines whether the mode switching operation is performed or not (step S11).

If YES, the process advances to step S17 where data in the image memory 43 for display is cleared to erase the live view image displayed in step S10.

On the other hand, when the mode changing operation is not performed, the process advances to step S12 to continue the following operation in the image-taking mode. In step S12, whether the user touches the shutter button 9 to set the state S1 or not is determined. If the digital camera 1 enters the state S1, the process of step S13 is performed.

In step S13, a preparing operation for performing the image-taking operation for recording, that is, an image-taking preparing operation is performed. Concretely, auto-focus control (AF), auto exposure control (AE), white balance control (WB) and the like are carried out. When the image-taking preparing operation is started, the CCD reading mode is alternately switched between the reading mode determined in the live view display (step S10) and the AF mode. In the digital camera 1, a live view image and an image for AE are alternately generated. At the time of obtaining the image for AF, the reading rate (frame rate) from the CCD image capturing device 20 can be increased.

After the image for AF is obtained, the image for AF is supplied to the AF evaluation value computing unit 27, and the AF evaluation value computing unit 27 computes the evaluation value for AF. The overall control unit 30 performs the AF control on the basis of the evaluation value for AF.

After the live view image is obtained, the live view image is supplied to the photometric computing unit 28, and photometric computation is carried out. When a live view image is inputted, the photometric computing unit 28 divides the image into a plurality of blocks each having 15 pixels in the vertical direction and 20 pixels in the horizontal direction irrespective of the display image size. For example, when the live view image has the size of 320 pixels in the horizontal direction and 240 pixels in the vertical direction, each block consists of 16×16 pixels. By adding luminance values of a plurality of pixels included in each block, the photometric computing unit 28 calculates the representative luminance value of each block. By obtaining the product of the representative luminance value obtained from each block and a weighted value assigned to each block and accumulating products obtained from the blocks, the evaluation value for AE is computed.

When the sizes of live view images are different from each other, the number of pixels included in each block varies. Consequently, even if brightness is the same, the representative luminance values obtained in the above-described manner become different values, and the overall control unit 30 cannot evaluate the evaluation value for AE with a predetermined evaluation reference.

Therefore, the photometric computing unit 28 of the embodiment is constructed so that the evaluation value for AE is outputted in a normalized state by normalizing the representative luminance values so that a predetermined evaluation reference can be applied even when the sizes of live view images are different.

Concretely, when the live view image has the size of 320 pixels in the horizontal direction and 240 pixels in the vertical direction, the representative luminance value obtained from each block is multiplied by 64 times. When the live view image has the size of 640 pixels in the horizontal direction and 480 pixels in the vertical direction, by multiplying the representative value obtained from each block by 16 times, the evaluation value for AE is calculated.

When the live view image has the size of 960 pixels in the horizontal direction and 720 pixels in the vertical direction, an image having 1,280 pixels in the horizontal direction and 960 pixels in the vertical direction is generated from an original image having the size of 2,560 pixels in the horizontal direction and 960 pixels in the vertical direction, and photometric computation is applied to the generated image. By multiplying the representative luminance value obtained from each block by four times, the evaluation value for AE is calculated.

In the case where the live view image is generated in the full frame mode, photometric computation is applied to an original image having the size of 2,560 pixels in the horizontal direction and 1,920 pixels in the vertical direction, the representative luminance value obtained from each block is used as it is, and the evaluation value for AE is calculated.

By executing such computation, the representative luminance value obtained from each block is normalized. The overall control unit 30 can evaluate the evaluation value for AE with a predetermined evaluation reference irrespective of the size of the live view image. Thus, efficient AE control can be realized.

The WB control is performed on the basis of the live view image. As the WB control, computation similar to the above can be applied by using the color signals of R, G and B in place of the representative luminance value in the photometric computation. Each of the AE control and WB control can be appropriately executed not necessarily in the state S1 but during live view display.

In the state S1, at the time of generating a live view image, the CCD reading mode may be changed to the octuple-speed mode. That is, by alternately repeating the AF mode and the octuple-speed mode, the image-taking preparing operation is performed. By generating a live view image in the octuple-speed mode irrespective of the resolution of the display device 2, after the digital camera 1 enters the state S1, the frame rate of the live view display can be increased and the motion of the subject can be grasped more easily. Consequently, the image-taking operation can be performed without missing a chance to take a good picture. In this case, in the resolution converting unit 26, an interpolating process is executed in accordance with the display resolution of the display device 2.

The image-taking preparing operation in the state S1 is performed as describe above. After the image-taking preparing operation is finished, the program returns to step S10. As long as the state S1 continues, the image-taking preparing operation in step S13 is repeatedly executed.

Subsequently, when the user fully depresses the shutter button 9, the digital camera 1 enters the state S2. Consequently, step S14 is determined as “YES” and the process advances to step S15.

In the state S2, an operation of capturing an image for recording is performed and a recording process for recording the taken image (captured image) into the memory card 90 is performed (step S15).

FIG. 10 is a flowchart showing the details of the recording process. When the recording process is started, first, the overall control unit 30 temporarily stores data in the present CCD recording mode and the contents of the resolution converting process (step S120). The overall control unit 30 changes the CCD reading mode to the full frame mode (step S122) and determines the contents of the resolution converting process so as to be adapted to the recording resolution (the number of pixels for recording) which is set by the user (step S123).

After the exposure control is executed (step S124), taken image data is read from the CCD image capturing device 20 (step S125). The resolution converting unit 26 performs the resolution converting process determined in step S123 and the resultant image data is temporarily stored in the image memory 44.

After the image-taking operation is finished, the overall control unit 30 resets the CCD reading mode and the resolution converting process to the state stored in step S120 (step S126).

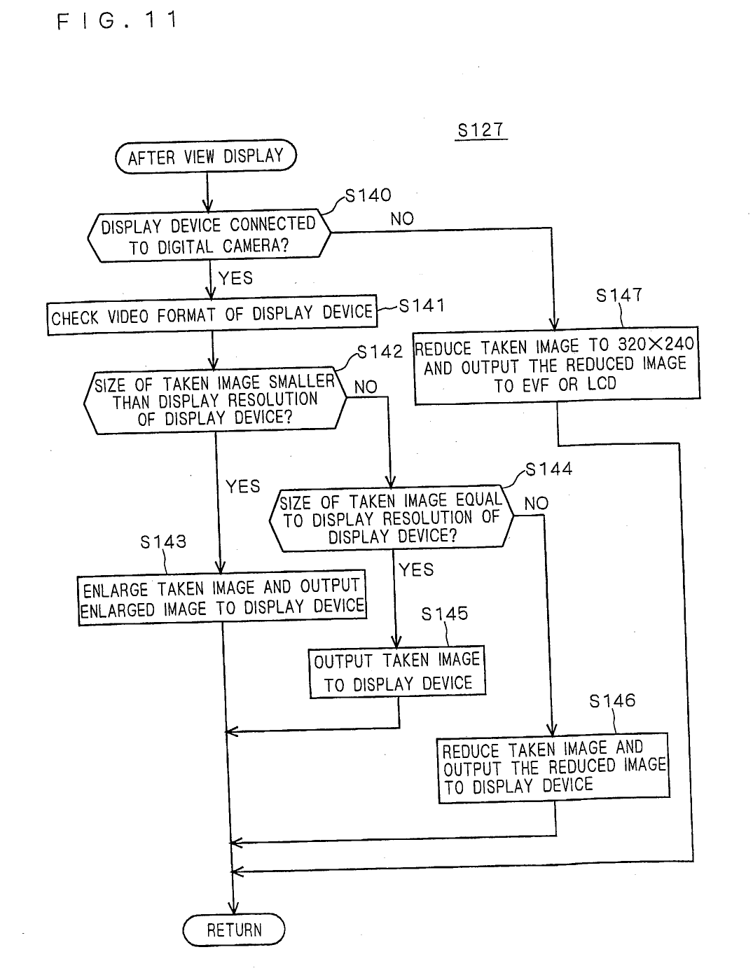

The overall control unit 30 performs the after view display on the basis of the image stored in the image memory 44 (step S127). FIG. 11 is a flowchart showing the details of the after view display.

When the after view display is started, whether the display device 2 is connected to the digital camera 1 or not is determined (step S140). If YES, in order to perform the after view display on the display device 2, the process advances to step S141. In the case where the display device 2 is not connected, in order to perform the after view display on the EVF 4 or LCD 5 provided for the digital camera 1, the process advances to step S147.

In the case where the display device 2 is connected, first, the overall control unit 30 checks the video format (display resolution) of the display device 2 (step S141). The overall control unit 30 also checks the size of the taken image stored in the image memory 44 and determines whether the size of the taken image is smaller than the display resolution of the display device 2 or not (step S142). When the size of the taken image is smaller than the display resolution of the display device 2, the taken image is enlarged so as to be adapted to the display resolution and the resultant image is stored into the image memory 43 for display. By the functions of the display switching unit 48 and communication circuit 49, the taken image stored in the image memory 43 for display is outputted as an image for display to the display device 2, thereby performing the after view display (step S143).

If NO in step S142, whether the size of the taken image is equal to the display resolution of the display device 2 or not is determined (step S144). If the size of the taken image size is equal to the display resolution of the display device 2, the taken image is stored as it is into the image memory 43 for display. By the functions of the display switching unit 48 and the communication circuit 49, the taken image stored in the image memory 43 for display is outputted as the image for display to the display device 2, thereby performing the after view display (step S145).

Further, if NO in step S144, the size of the taken image is larger than the display resolution of the display device 2. Consequently, the overall control unit 30 performs a process of reducing the size of the taken image so as to be adapted to the display resolution and stores the resultant image into the image memory 43 for display. By the functions of the display switching unit 48 and communication circuit 49, the taken image which is stored in the image memory 43 for display is outputted as an image for display to the display device 2, thereby performing the after view display (step S146).

On the other hand, when the display device 2 is not connected to the digital camera 1, the overall control unit 30 generates a reduced image having the size of 320 pixel in the horizontal direction and 240 pixels in the vertical direction from the taken image stored in the image memory 44 and stores the reduced image into the image memory 43 for display. By outputting the reduced image stored in the image memory 43 for display as an image for display to the EVF 4 or LCD 5 by the function of the display switching unit 48, the after view display is performed (step S147).

As described above, at the time of after view display, an after view image adapted to the display device for performing the after view display is generated. Thus, particularly, in the case of displaying an after view on the display device 2 provided on the outside of the digital camera 1, high-definition after-view display can be performed.

After completion of the after view display, the process advances to step S128 (FIG. 10) and determines whether the taken image data stored in the image memory 44 is recorded or not. The determination is made on the basis of the user operation. For example, the determination is made as NO when the user performs an erasing operation within predetermined time since the after view display is started. In the other cases, the determination is made as YES.

In the case of recording the taken image data, the overall control unit 30 generates a thumbnail image of the taken image (step S129). At this time, the thumbnail image is generated so as to be adapted to the display resolution of the EVF 4 and LCD 5. That is, the thumbnail image is an image consisting of 320 pixels in the horizontal direction and 240 pixels in the vertical direction.

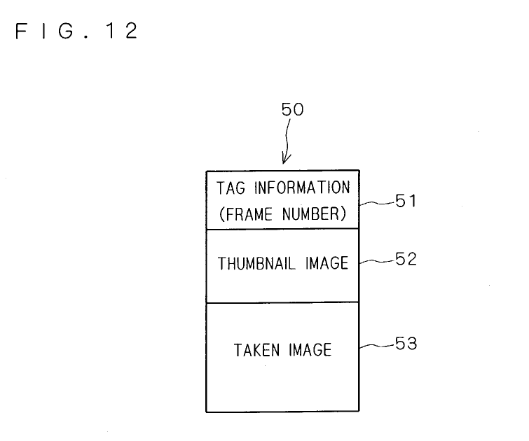

Subsequently, the overall control unit 30 generates an image file to be recorded on the memory card 90 (step S130). FIG. 12 is a diagram showing the structure of an image file 50. As shown in FIG. 12, the image file 50 has a region 51 for recording tag information, a region 52 for recording a thumbnail image, and a region 53 for recording a taken image. The tag information is information including information regarding image-taking conditions, frame number and the like. As shown in FIG. 12, by recording the taken image as the image file 50, the thumbnail image of the taken image and the tag information can be simultaneously managed.

After the image file 50 is generated, the overall control unit 30 accesses the memory card 90 and performs a process of recording the image file 50 (step S131). At this time, the thumbnail image data and the taken image data is compressed by the compressing/decompressing unit 46.

The recording process is performed in such a manner. As shown in FIG. 7, after the recording process (step S15) is finished, in order to enable the following image-taking operation to be performed, the process returns to step S10.

As described above, when the display device 2 is connected to the digital camera 1 in the image-taking mode, in each of the live view display and the after view display, an image for display is generated so as to be adapted to the display resolution of the display device 2. Therefore, in a case such that it is difficult for the user to check the details of an image displayed on the EVF 4 or LCD 5, by connecting the display device 2 capable of displaying an image of higher resolution than the EVF 4 and LCD 5 to the digital camera 1, a display image adapted to the display resolution of the display device 2 can be visually recognized. Thus, the user can easily check the state of the details of the image.

Particularly, the digital camera 1 is constructed so as to be able to detect the display resolution of the display device for performing the live view display and changing the reading method of the CCD image capturing device 20 in accordance with the display resolution at the time of live view display. Consequently, an image can be obtained from the CCD image capturing device 20 so as to be adapted to display resolution and high-definition image display utilizing the display resolution of the display device can be realized.

Generally, in the case of increasing the display resolution while maintaining a predetermined frame rate, the throughput of the digital camera 1 has to be increased. It causes increase in power consumption and cost. In the digital camera 1 of the embodiment, however, when the display resolution is higher than a predetermined resolution, the display frame rate in the display device is lowered and the overall control unit 30 decreases the rate of reading data from the CCD image capturing device 20. Thus, increase in power consumption and cost can be suppressed.

When the digital camera 1 shifts to the image-taking preparing operation, by increasing the reading rate of the CCD image capturing device 20, the frame rate of live view display can be increased. Consequently, the user can perform the image-taking operation without missing a chance for a good picture.

Since the reading rate of the CCD image capturing device 20 is increased at the time of AF control, it contributes to higher speed of the AF control and the operability of the digital camera 1 is improved.

The digital camera 1 is constructed to calculate the evaluation value for automatic exposure control on the basis of the image obtained from the CCD image capturing device 20. The evaluation value for AE is normalized so as to be evaluated by a predetermined evaluation reference irrespective of the image obtained from the CCD image capturing device 20 (or the number of display pixels in the display device 2). Consequently, in order to perform the live view display, even when the resolutions of images obtained from the CCD image capturing device 20 are different from each other, the AE control can be always performed with a constant evaluation reference. Thus, efficient AE control can be achieved.

Further, the digital camera 1 is constructed to generate a thumbnail image of a taken image obtained by the image-taking operation so as to be adapted to the display resolution of the EVF 4 or LCD 5. Consequently, at the time of displaying the thumbnail image on the EVF 4 or LCD 5, the process of enlarging or reducing an image is unnecessary, and image display can be performed efficiently.

1-4. Process in Reproduction Mode

The process in the reproduction mode in the digital camera 1 having the above configuration will now be described. In the reproduction mode, an image taken by a digital camera other than the digital camera 1 can be also reproduced. In some cases, therefore, the size of a thumbnail image is larger than the size of 320 pixels in the horizontal direction and 240 pixels in the vertical direction.

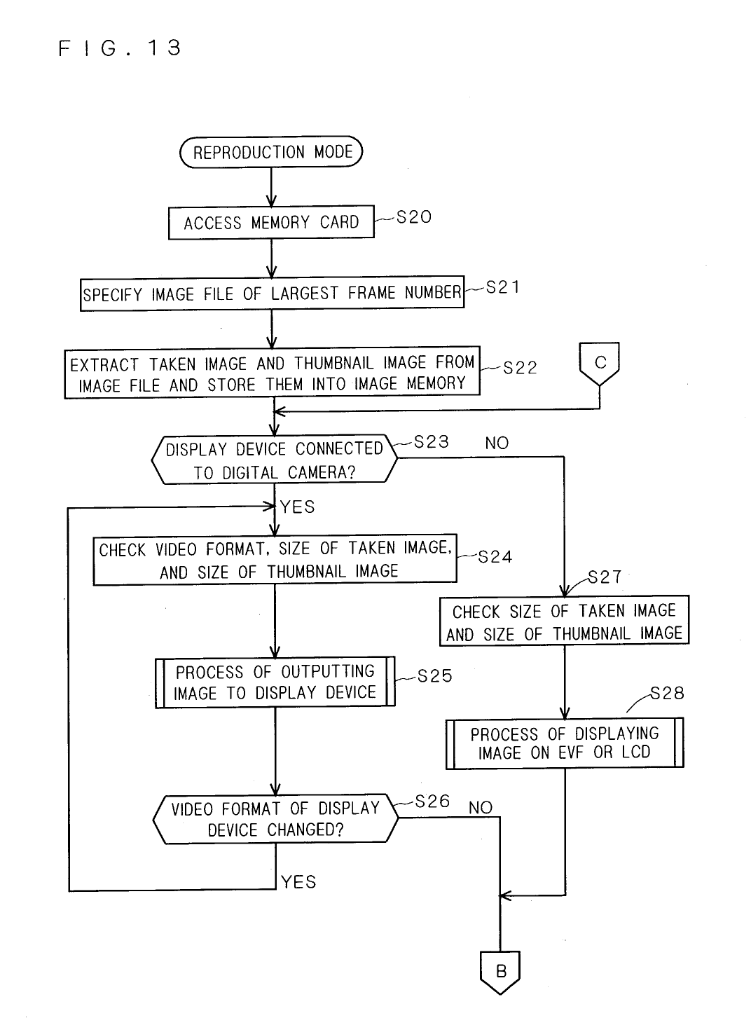

FIGS. 13 to 16 are flowcharts showing the processing sequence of the digital camera 1 in the reproduction mode.

In the reproduction mode, the overall control unit 30 accesses the memory card 90 (step S20) and specifies an image file of the largest frame number among image files stored in the memory card 90 (step S21). That is, the image file taken most recently is specified. The taken image and the thumbnail image included in the specified image file are extracted and stored into the image memory 44 (step S22). In the case where the compressing process is performed on the taken image and the thumbnail image, the decompressing process is performed by the compressing/decompressing unit 46, and the processed images are stored into the image memory 44.

The overall control unit 30 determines whether the display unit 2 is connected to the digital camera 1 or not (step S23). If YES, the process advances to step S24. If NO, the process advances to step S27.

When the display device 2 is connected to the digital camera 1, the overall control unit 30 checks the video format (display resolution) of the display device 2 and the size of each of the taken image and the thumbnail image stored in the image memory 44 (step S24). After that, the process of outputting an image to the display device 2 is executed (step S25).

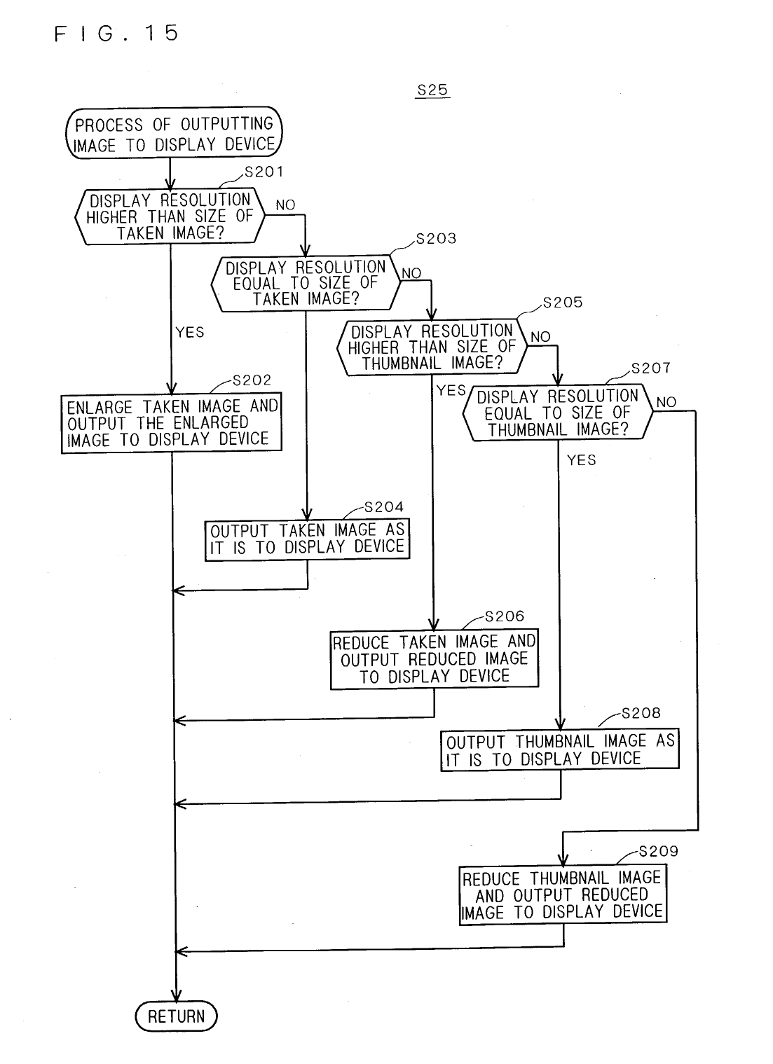

FIG. 15 is a flowchart showing the detailed processes of step S25. First, the overall control unit 30 determines whether the display resolution of the display device 2 is higher than the size of the taken image or not (step S201). If YES, the overall control unit 30 enlarges the taken image so as to be adapted to the display resolution and stores the enlarged image to the image memory 43 for display. By the functions of the display switching unit 48 and the communication circuit 49, the enlarged taken image stored in the image memory 43 for display is outputted as an image for display to the display device 2, thereby performing reproduction and display (step S202).

If NO in step S201, whether the display resolution of the display device 2 is equal to the size of the taken image size or not is determined (step S203). When the display resolution of the display device 2 is equal to the size of the taken image, the taken image is stored as it is into the image memory 43 for display. By the functions of the display switching unit 48 and the communication circuit 49, the taken image stored in the image memory 43 for display is outputted as the image for display to the display device 2, thereby performing reproduction and display (step S204).

If NO in step S203, whether the display resolution of the display device 2 is higher than the size of the thumbnail image or not is determined (step S205). When the display resolution of the display device 2 is higher than the size of the thumbnail image, the taken image is reduced so as to be adapted to the display resolution and the reduced image is stored into the image memory 43 for display. By the functions of the display switching unit 48 and communication circuit 49, the reduced taken image stored in the image memory 43 for display is outputted as the image for display to the display device 2, thereby performing reproduction and display (step S206).

Further, if NO in step S205, whether the display resolution of the display device 2 is equal to the size of the thumbnail image or not is determined (step S207). When the display resolution of the display device 2 is equal to the size of the thumbnail image, the thumbnail image is stored as it is into the image memory 43 for display. By the functions of the display switching unit 48 and communication circuit 49, the thumbnail image stored in the image memory 43 for display is outputted as an image for display to the display device 2, thereby performing reproduction and display (step S208).

If NO in step S207, the display resolution of the display device 2 is lower than the size of the thumbnail image. Consequently, the thumbnail image is reduced so as to be adapted to the display resolution and the resultant image is stored into the image memory 43 for display. By the functions of the display switching unit 48 and communication circuit 49, the reduced thumbnail image stored in the image memory 43 for display is outputted as the image for display to the display device 2, thereby performing reproduction and display (step S209).

In the process of outputting an image to the display device 2 (step S25), an image for display is generated so as to be adapted to display resolution of the display device 2 and reproduction and display is performed. Particularly, when the display resolution of the display device 2 is equal to the size of the thumbnail image or when the display resolution of the display device 2 is lower than the size of the thumbnail image, an image for display is not generated from the taken image but reproduction and display is performed by using the thumbnail image. Consequently, the processing efficiency of generating an image for display can be improved. Since it is effective also in the case of reproducing images of digital cameras of different sizes of thumbnail images, flexibility is high.

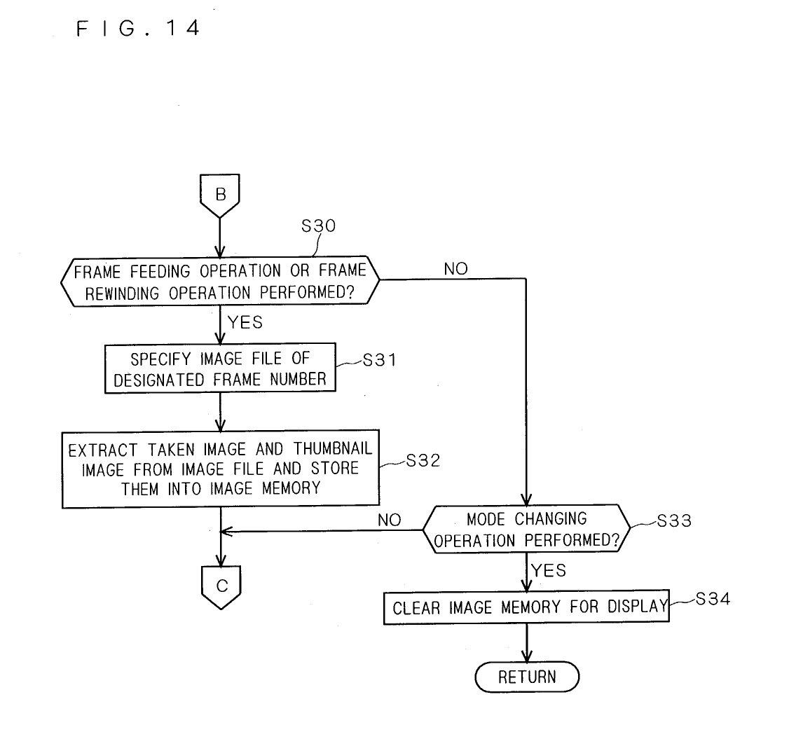

When the process of outputting an image to the display device 2 (step S25) is finished, the process advances to step S26 (FIG. 13) and determines whether the video format of the display device 2 has been changed or not. In the case where the video format is changed, the process returns to step S24 and the overall control unit 30 performs a reproducing and displaying process again on the display device 2. In the case where the video format of the display device 2 has not been changed, the process advances to step S30 (FIG. 14).

On the other hand, when the display device is not connected to the digital camera 1 (in the case of NO) in step S23, the overall control unit 30 checks the size of each of the taken image and the thumbnail image stored in the image memory 44 (step S27) and executes the display process on the EVF 4 or LCD 5 (step S28).

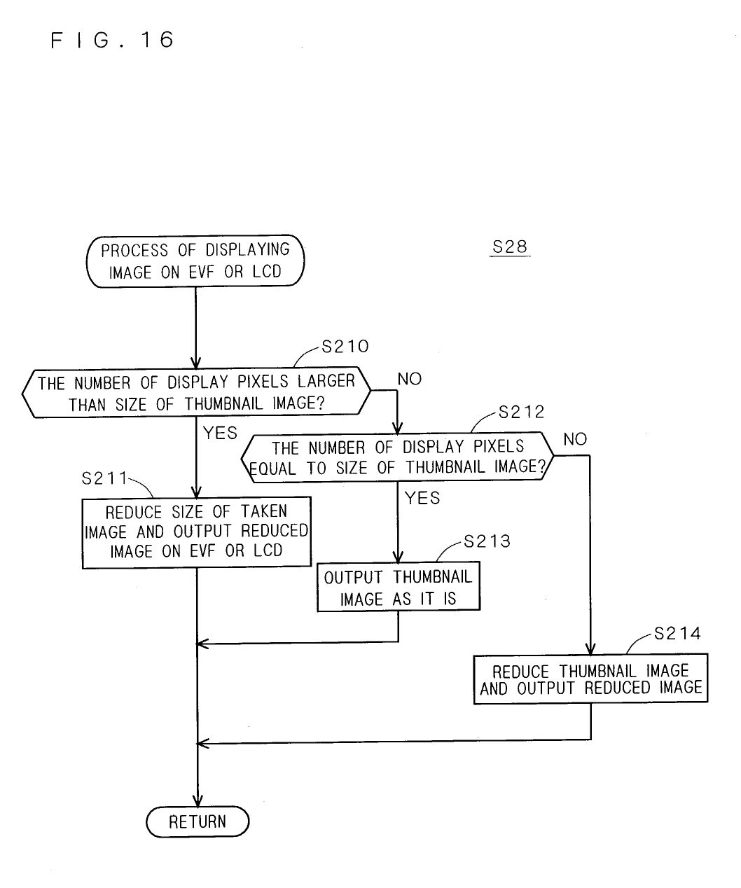

FIG. 16 is a flowchart showing the detailed processes of step S28. First, the overall control unit 30 determines whether the number of pixels (320 pixels in the horizontal direction and 240 pixels in the vertical direction in the embodiment) of the EVF 4 or LCD 5 is larger than that of the thumbnail image or not (step S210). In the case of reproducing and processing an image file taken by the digital camera 1 in the embodiment, step S201 is not determined as YES. However, in the case of reproducing and processing an image file taken by another digital camera 1, step S201 may be determined as YES.

When the number of display pixels of the EVF 4 or LCD 5 is larger than the size of the thumbnail image, the taken image is reduced so as to be adapted to the display resolution, and the reduced image is stored into the image memory 43 for display. By the function of the display switching unit 48, the reduced taken image stored in the image memory 43 for display is outputted as the image for display to the EVF 4 or LCD 5, thereby performing reproduction and display (step S211).

If NO in step S210, whether the number of display pixels of the EVF 4 or LCD 5 is equal to the size of the thumbnail image or not is determined (step S212). In the case of reproducing the image file taken by the digital camera 1 in the embodiment, step S212 is not determined as NO. However, in the case of reproducing the image file taken by another digital camera 1, step S212 may be determined as NO.

When the number of display pixels of the EVF 4 or LCD 5 is equal to the size of the thumbnail image, the thumbnail image is stored as it is into the image memory 43 for display. By the function of the display switching unit 48, the thumbnail image stored in the image memory 43 for display is outputted as an image for display to the EVF 4 or LCD 5, thereby performing reproduction and display (step S213).

If NO in step S212, since the number of display pixels of the EVF 4 or LCD 5 is smaller than the size of the thumbnail image, the thumbnail image is reduced so as to be adapted to the display resolution, and the reduced image is stored into the image memory 43 for display. By the function of the display switching unit 48, the reduced thumbnail image stored in the image memory 43 for display is outputted as an image for display to the EVF 4 or LCD 5, thereby performing reproduction and display (step S214).

As described above, in the displaying process on the EVF 4 or LCD 5 (step S28), an image for display is generated so as to be adapted to the display resolution of the EVF 4 or LCD 5 and reproduced and displayed. Particularly, in the case of reproducing an image file taken by the digital camera 1, the image file can be reproduced and displayed as it is by using the thumbnail image. Thus, the processing efficiency at the time of the reproduction can be improved.

After the displaying process on the EVF 4 or LCD 5 (step S28) is finished, the process advances to step S30 (FIG. 14).

In step S30, the overall control unit 30 determines whether or not a frame feeding operation of a frame rewinding operation is performed by the user. If YES, the process advances to step S31. The overall control unit 30 accesses the memory card 90, specifies an image file of the designated frame number (step S31), extracts a taken image and a thumbnail image from the image file, and stores the images into the image memory 44 (step S32). After that, the process returns to step S23 and the overall control unit 30 repeats the reproducing and displaying process.

If NO in step S30, the overall control unit 30 determines whether the mode changing operation has been performed or not (step S33). When the mode changing operation is not also performed, the process returns to step S23 and the overall control unit 30 repeats the reproducing and displaying process. On the other hand, when the mode changing operation is performed, the overall control unit 30 clears the image memory 43 for display to erase the reproduction and display state of an image (step S34) and finishes the reproduction mode.

In the reproduction mode, an image for display is generated by using an image of resolution higher than the display resolution so that high-definition display can be performed in the reproduction and display. Since an image for display is generated by effectively using a thumbnail image, as compared with the case of always generating an image for display from a taken image, more efficient process can be performed. That is, not only in the case where an image is reproduced and displayed on the EVF 4 or LCD 5 but also in the case where the video format of 525i or 525p is applied in the display device 2, an image for display is generated by using a thumbnail image. Thus, a useless process of generating the image for display from the taken image can be avoided.

That is, the digital camera 1 reproduces and displays an image on the basis of an image file including a taken image and a thumbnail image of the taken image. When the display device 2 is connected to the digital camera 1, on the basis of the display resolution of the display device 2, an image to be reproduced is selected from the taken image and the thumbnail image, and image data for display is generated and outputted. Consequently, efficient reproduction and display can be performed.

Both of the taken image and the thumbnail image are temporarily stored in the image memory 44 and an image to be reproduced is selected and displayed from the image memory 44 on the basis of the display resolution of the display device 2. Therefore, for example, even in the case where the display resolution of the display device 2 is changed, it becomes unnecessary to access the image file again. Thus, display resolution can be adjusted smoothly.

Further, by performing the resolution changing process on the image to be reproduced on the basis of the display resolution of the display device 2, image data for display adapted to the display resolution can be generated, and reproduction and display in the display device 2 can be performed in an optimum state.

2. Second Embodiment

A case of performing a process different from the above-described process in the reproduction mode will be described. In the reproduction mode in the first embodiment, taken image data from a file is prestored as image data of the number of pixels which is the same as that in the image-taking into the image memory 44 and, after that, resolution conversion is carried out in accordance with a reproduction size. In a second embodiment, different from the first embodiment, taken image data included in an image file is decompressed and, at the time of storing the image data into the image memory 44, resolution conversion according to the reproduction size is performed on the image data. The configuration of the digital camera 1 and the like is similar to the above.

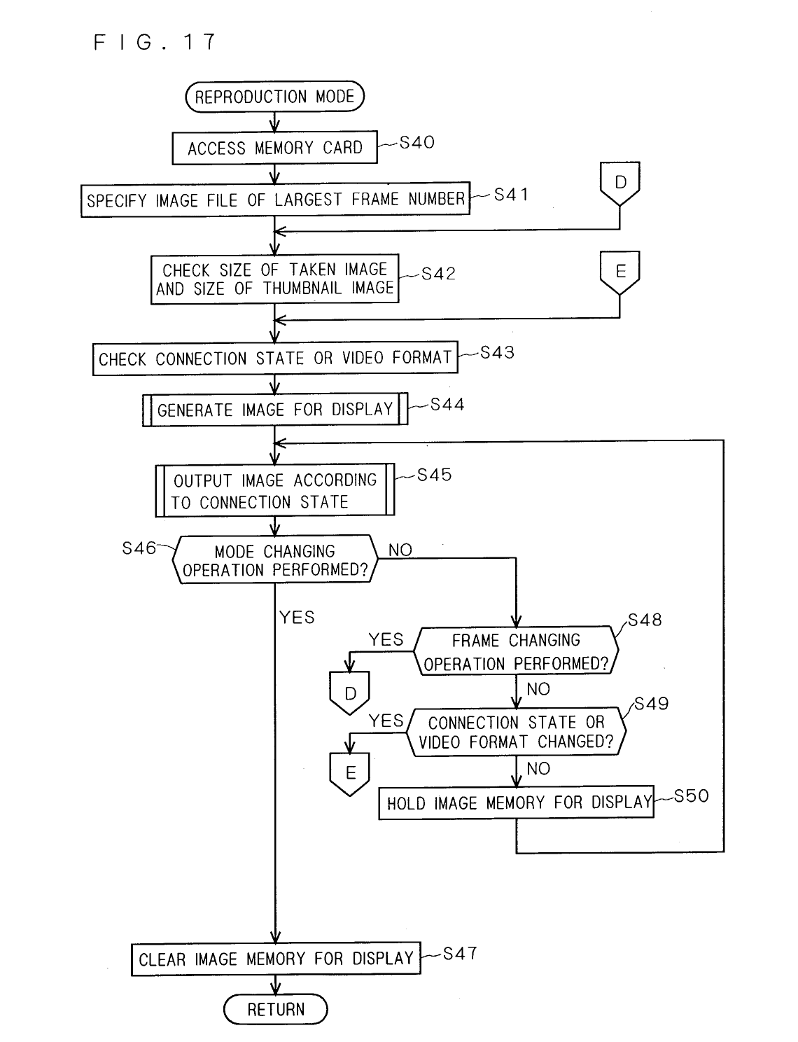

FIGS. 17 to 20 are flowcharts showing processes in the reproduction mode in the second embodiment.

In the reproduction mode, the overall control unit 30 accesses the memory card 90 (step S40) and specifies an image file of the largest frame number among image files stored in the memory card 90 (step S41). That is, the image file taken most recently is specified. The overall control unit 30 checks the size of a taken image and the size of a thumbnail image included in the specified image file (step S42).

The overall control unit 30 checks the connection state of the display device 2 to the digital camera 1. If the display device 2 is connected to the digital camera 1, the overall control unit 30 checks the video format (step S43) and the process advances to a process of generating an image for display (step S44).

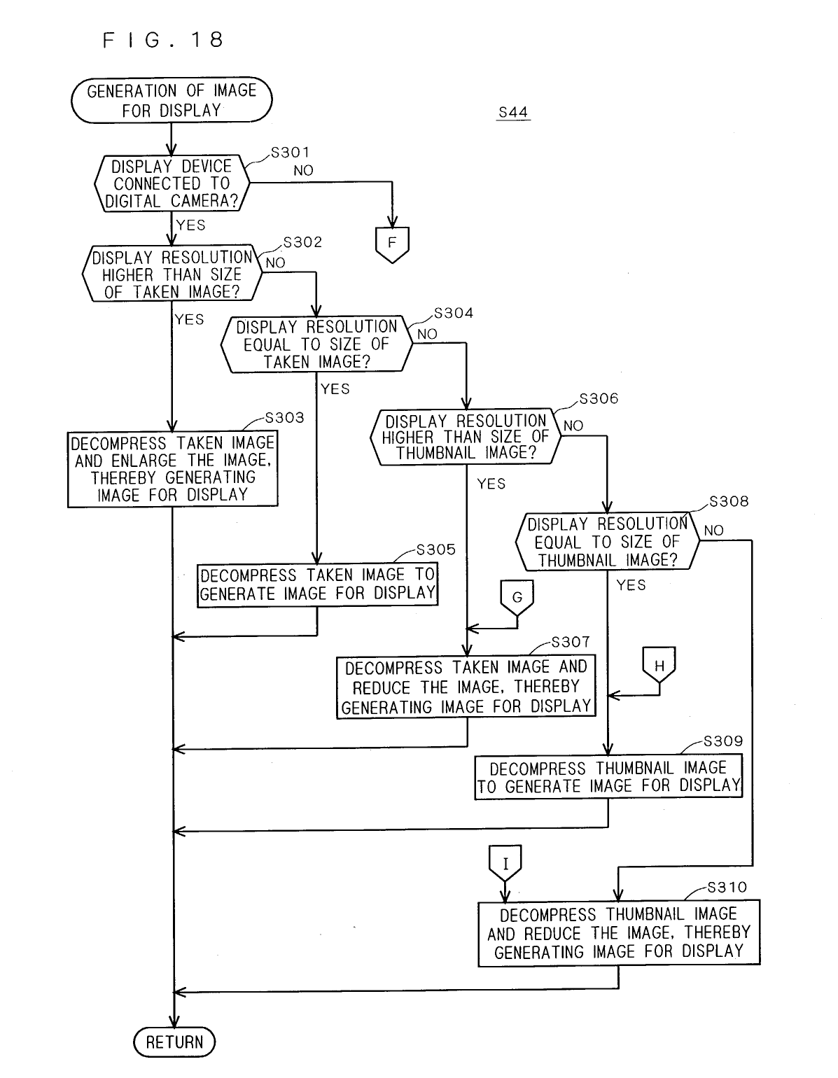

FIGS. 18 and 19 are flowcharts showing the detailed process of step S44. First, the overall control unit 30 determines whether the display device 2 is connected to the digital camera 1 or not (step S301). If YES, the process advances to step S302. If NO, the process advances to step S311 (FIG. 19).

When the display device 2 is connected to the digital camera 1, the overall control unit 30 determines whether the display resolution of the display device 2 is higher than the size of the taken image or not (step S302). If YES, the overall control unit 30 extracts a taken image included in the image file, performs a decompressing process on the taken image, enlarges the taken image so as to be adapted to the display resolution, and stores the enlarged image to the image memory 43 for display (step S303).

If NO in step S302, whether the display resolution of the display device 2 is equal to the size of the taken image size or not is determined (step S304). When the display resolution of the display device 2 is equal to the size of the taken image, the taken image included in the image file is extracted and decompressed and the resultant image is stored into the image memory 43 for display (step S305).

If NO in step S304, whether the display resolution of the display device 2 is higher than the size of the thumbnail image or not is determined (step S306). When the display resolution of the display device 2 is higher the size of the thumbnail image, the taken image included in the image file is extracted, decompressed and further reduced so as to be adapted to the display resolution and the resultant image is stored into the image memory 43 for display (step S307). By reducing the taken image, not by enlarging the thumbnail image, an image for display can be generated with high definition.

If NO in step S306, whether the display resolution of the display device 2 is equal to the size of the thumbnail image or not is determined (step S308). When the display resolution of the display device 2 is equal to the size of the thumbnail image, the thumbnail image included in the image file is extracted and decompressed and the resultant image is stored as it is into the image memory 43 for display (step S309).

Further, if NO in step S308, the display resolution of the display device 2 is lower than the size of the thumbnail image. Consequently, the overall control unit 30 extracts the thumbnail image included in the image file, decompresses the image, further, reduces the image so as to be adapted to the display resolution, and stores the resultant into the image memory 43 for display (step S310).

On the other hand, when the display device 2 is not connected to the digital camera 1, the overall control unit 30 determines whether or not the size of the thumbnail image is smaller than the number of display pixels of the EVF 4 or LCD 5 (step S311). If YES, the process advances to step S307, and the overall control unit 30 extracts the taken image included in the image file, decompresses it, and further reduces it so as to be adapted to the display resolution of the EVF 4 or LCD 5. The image for display obtained as a result is stored into the image memory 43 for display.

If NO in step S311, the overall control unit 30 determines whether or not the size of the thumbnail image is equal to the number of pixels of the EVF 4 or LCD 5 (step S312). If YES, the process advances to step S309 and, the overall control unit 30 extracts the thumbnail image included in the image file, decompresses it, and stores the resultant image into the image memory 43 for display.

Further, if NO in step S311, the process advances to step S310, and the overall control unit 30 extracts the thumbnail image included in the image file, decompresses it and, further, reduces it so as to be adapted to the display resolution of the EVF 4 or LCD 5. The image for display obtained as a result is stored into the image memory 43 for display.

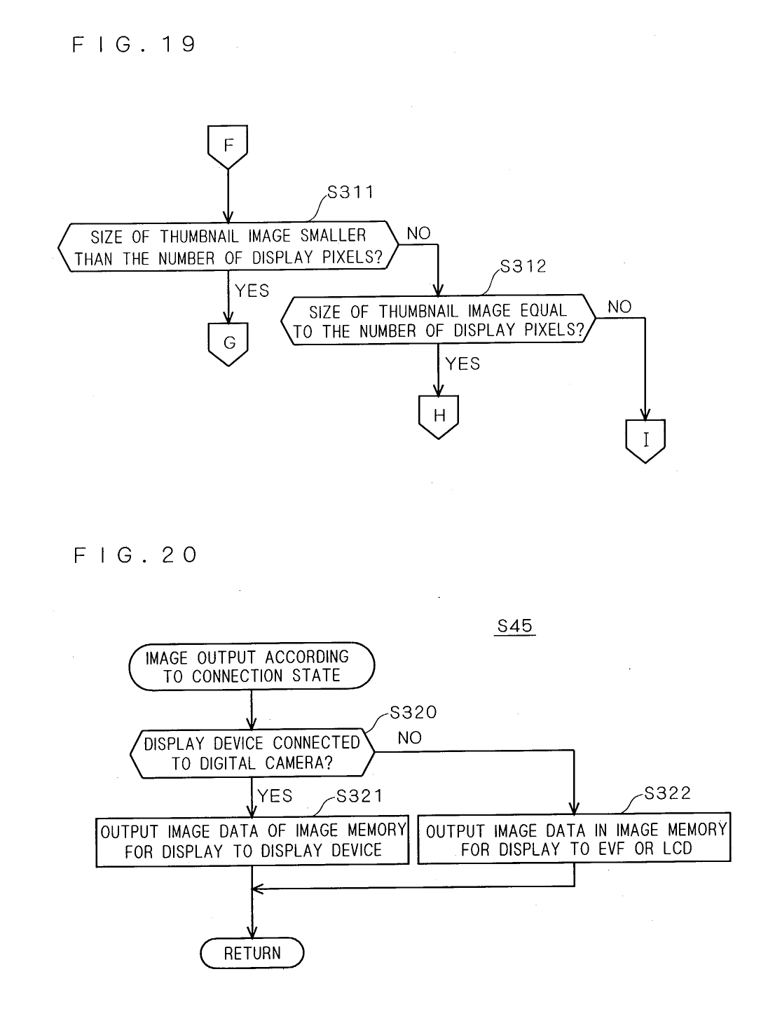

Referring again to FIG. 17, after the image for display is generated and stored into the image memory 43 for display, in step S45, an image outputting process according to the connection state is performed. FIG. 20 is a flowchart showing the details of step S45. Whether the display device 2 is connected to the digital camera 1 or not is determined (step S320). If YES, by the functions of the display switching unit 48 and communication circuit 49, the image for display stored in the image memory 43 for display is outputted to the display device 2, thereby performing reproduction and display (step S321). If NO, by outputting the image for display stored in the image memory 43 for display to the EVF 4 or LCD 5 by the function of the display switching unit 48, reproduction and display is performed (step S322).

By performing the reproduction and display, the image for display adapted to the display resolution can be reproduced and displayed.

In step S46, whether a mode changing operation has been performed by the user or not is determined. If NO, the process advances to step S48. If YES, the overall control unit 30 clears the image memory 43 for display to erase the reproduction and display state of the image (step S47), and finishes the reproduction mode.

In step S48, the overall control unit 30 determines whether or not a frame feeding operation of a frame rewinding operation is performed by the user. If YES, the process advances to step S42. The overall control unit 30 accesses the memory card 90, checks the size of each of a taken image and a thumbnail image included in an image file of a designated frame number and, after that, repeats similar processes.

If there is no operation input by the user, the overall control unit 30 determines whether or not there is a change in the connection state or video format (step S49). When there is a change, the process returns to step S43 and the overall control unit 30 repeats similar processes. On the other hand, when there is no change, the process returns to step S45, and the overall control unit 30 holds the image for display stored in the image memory 43 for display as it is and continues the reproduction and display.

In the reproduction mode in the embodiment, the display resolution at the time of reproduction and display is detected and, on the basis of the size of each of the taken image and the thumbnail image, image data for display adapted to the display resolution is generated. Consequently, the efficiency of use of the image memory 44 for temporarily storing the taken image and thumbnail image increases at the time of reproduction.

3. Third Embodiment

In a third embodiment, a case of instructing a change in the video format from the digital camera 1 side to the display device 2 in a state where the display device 2 is connected to the digital camera 1 will be described. The other configuration of the digital camera 1 is similar to that in the first embodiment.

3-1. Outline of Operation

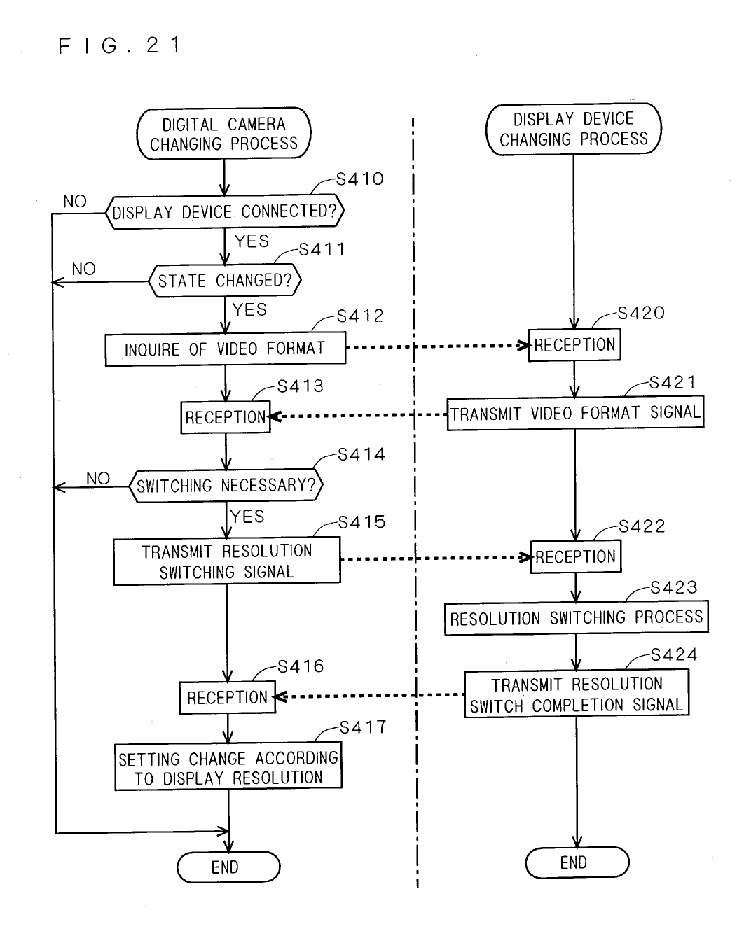

FIG. 21 is a flowchart showing a linking operation in the image-taking system 100 in the case of changing the video format of the display device 2 from the digital camera 1. The overall control unit 30 of the digital camera 1 determines whether the display device 2 is connected or not (step S410). Subsequently, the overall control unit 30 determines whether there is a change in the mode by the operation of the mode switching dial 12 in the digital camera 1 by the user or a change in the internal state of the digital camera 1 or not by the frame feeding operation in the reproduction mode or various setting changing operation in a setting mode, or the like (step S411). In a case where the display device 2 is not connected or in the case where there is no change in the internal state of the digital camera 1, it is unnecessary to change the video format so that the routine is finished.

On the other hand, when there is a change in the state of the digital camera 1, an inquiry of the present video format is sent from the digital camera 1 to the display device 2 (step S412). Concretely, a signal for inquiring of a video format is transmitted from the digital camera 1 to the display device 2.

On receipt of the inquiry (step S420), the display device 2 transmits a video format signal indicative of the present video format to the digital camera 1 (step S421). By receiving the video format signal, the digital camera 1 can identify the display resolution in the present display device 2 (step S413).

The overall control unit 30 determines whether the video format has to be switched or not (step S414). For example, in the case where the user performs an operation for changing the video format by operating the operating unit of the digital camera 1 or the size of taken image data to be reproduced by the frame feeding operation changes from 640×480 pixels to 2,560×1,920 pixels, it is determined that the switching is necessary. In the case where it is unnecessary to switch the video format, the process is finished. On the other hand, when the switching is necessary, a resolution switching signal is generated by the digital camera 1 and transmitted to the display device 2 (step S415).

When the resolution switching signal is received (step S422), the display device 2 performs a process for making a switch to the display resolution indicated by the resolution switching signal (resolution switching process) (step S423). On completion of the resolution switching process, the display device 2 transmits a resolution switch completion signal to the digital camera 1 (step S424).

By receiving the resolution switch completion signal, the digital camera 1 can recognize that the video format in the display device 2 has been changed (step S416). After that, the setting state of the digital camera 1 is changed according to the display resolution and the format of image data for display to be transmitted to the display device 2 is changed (step S417).

In step S417, in the image-taking mode, as already described in the first embodiment, the process of changing the CCD reading mode for live view display and the resolution converting process according to the display resolution of the display device 2 are set.

On the other hand, in the case of the reproduction mode and the setting mode, it is unnecessary to change the setting of the CCD reading mode. However, the resolution converting process is set in accordance with the display resolution of the display device 2.

By such a linking operation, the video format (display resolution) of the display device 2 can be changed from the digital camera 1 side.

3-2. Process in Image-Taking Mode

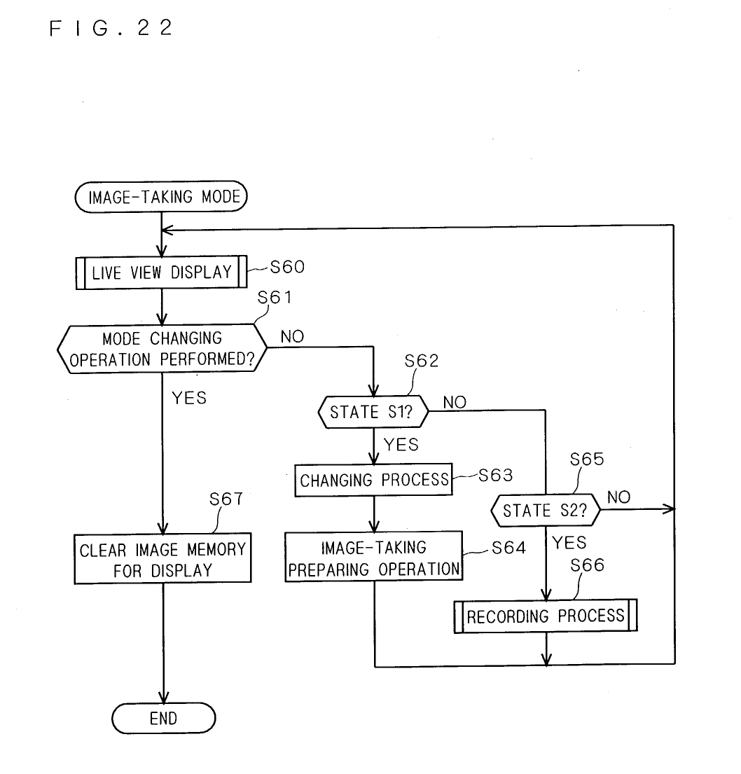

A concrete example of automatically instructing a change in the video format from the camera side to the display device 2 in accordance with a change in the state of the digital camera 1 will be described. FIGS. 22 to 24 are flowcharts showing the processing sequence of the digital camera 1 in the image-taking mode.

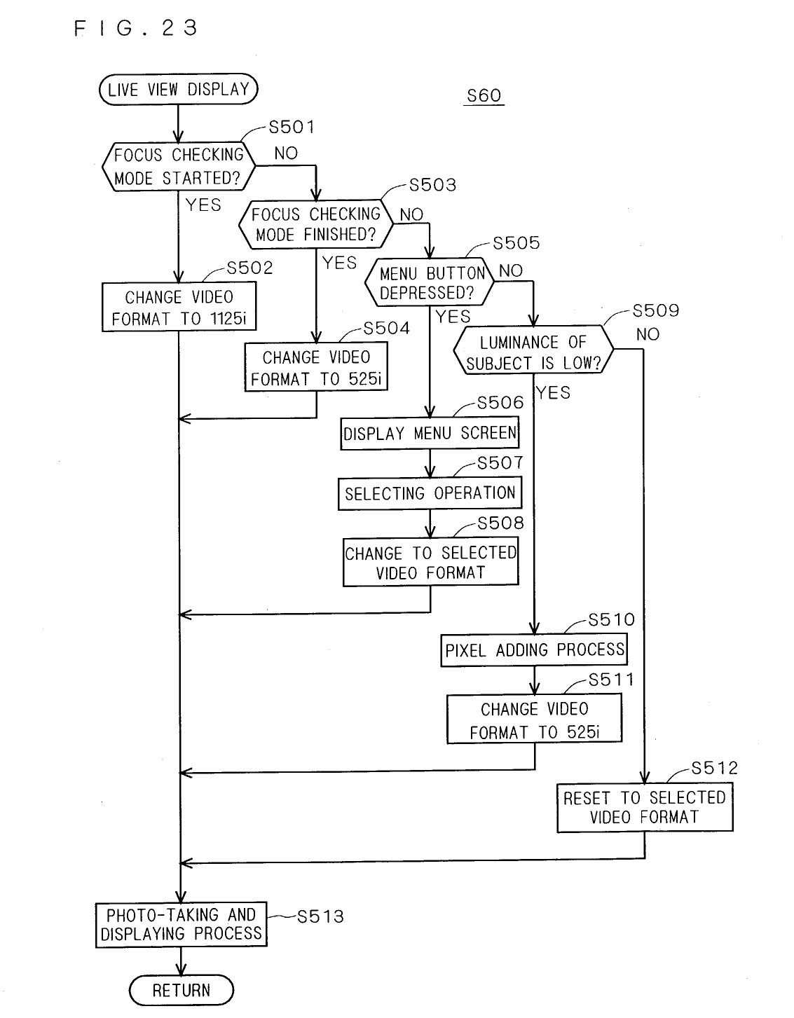

First, in the image-taking mode, a process for live view display is performed in the digital camera 1 (step S60). FIG. 23 is a flowchart showing the details of the live view displaying process. In the live view displaying process, the overall control unit 30 determines whether a focus checking mode is started or not by the user operation of the function operating unit 11 (step S501).

The focus checking mode is a mode for the user to accurately know the focus state of an image in cases such that a focus state is almost achieved in an AF control or at the time of MF setting. The mode is set when the focus checking mode is effectively set.

At the time of starting the focus checking mode, the overall control unit 30 generates a resolution switching signal for changing the video format of the display device 2 to 1125i (or 1125p) and transmits the signal to the display device 2, thereby changing the display resolution of the display device 2 to high resolution (step S502).

If NO in step S501, whether the focus checking mode is finished or not is determined (step S503). In the case of finishing the focus checking mode, the overall control unit 30 generates a resolution switching signal for changing the video format of the display device 2 to 525i (or 525p) and transmits it to the display device 2, thereby changing the display resolution of the display device 2 to low resolution (step S504).

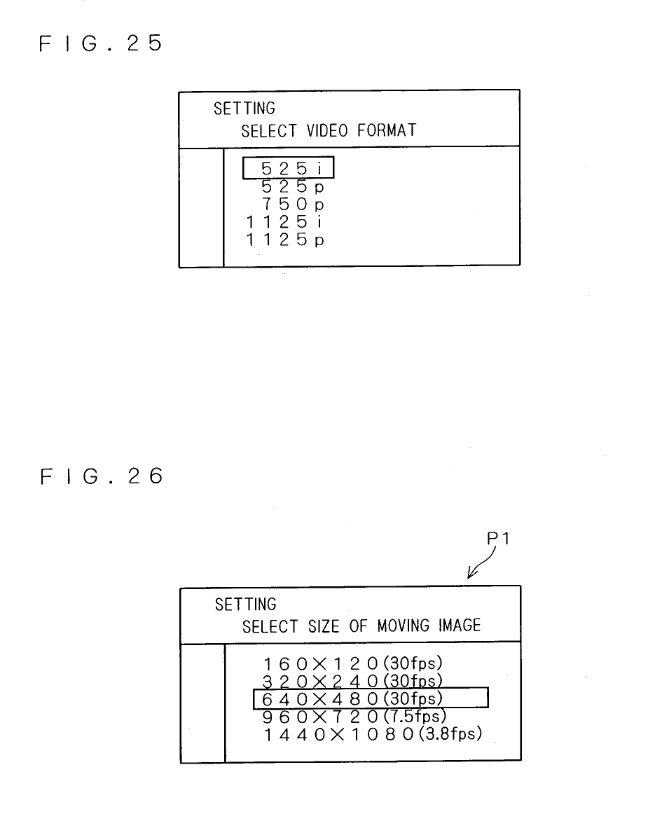

If NO in step S503, the overall control unit 30 determines whether the menu button 6 has been depressed or not (step S505). If YES, the overall control unit 30 displays a menu screen for changing the video format to the EVF 4 or LCD 5 (step S506). The menu screen displayed on the EVF 4 or LCD 5 at this time is, for example, as shown in FIG. 25. A list of video formats displayed on the menu screen are video formats which can be applied to the display device 2. The user operates the control button 7, thereby selecting one of the plurality of video formats (step S507). The overall control unit 30 generates the resolution switching signal so as to change the video format to the video format selected by the user and transmits the generated signal to the display device 2 (step S508). In such a manner, the display resolution desired by the user is set to be effective in the display device 2.

If NO in step S505, the overall control unit 30 determines whether the luminance of the subject is low or not (step S509). For example, by determining whether an average luminance of an image obtained from the CCD image capturing device 20 before that is lower than a predetermined value or not, whether the luminance of the subject is low or not can be determined.

When it is determined that the luminance of the subject is low, a pixel adding process is executed on an image obtained for live view display from the CCD image capturing device 20 (step S510). That is, by adding signals obtained from a plurality of neighboring pixels, a low luminance state is eliminated and a high-luminance image is generated. Consequently, the resolution of an image obtained by performing the pixel adding process becomes lower than that of an image obtained from the CCD image capturing device 20.

After performing the pixel adding process, the overall control unit 30 generates a resolution switching signal for changing the video format of the display device 2 to 525i (or 525p) and transmits the signal to the display device 2, thereby changing the display resolution of the display device 2 to low resolution (step S511).

If NO in step S509, the state change for changing the video format is eliminated. Consequently, to reset the video format to the video format selected in step S507 before that, the resolution switching signal is generated and transmitted to the display device 2 (step S512), thereby resetting the display resolution of the display device 2 to the original state.

After performing the processes in steps S502, S504, S508, S511, and S512, image acquisition for live view display and a process of generating display data adapted to a video format is performed. The image data for display is transmitted to the display device 2 (step S513) and a live view with the set display resolution is displayed on the display device 2.

Referring again to the flowchart of FIG. 22, when the live view display is performed (step S60), the overall control unit 30 determines whether the mode changing operation has been performed or not (step S61).

If YES, the process advances to step S67 and clears the data in the image memory 43 for display to erase the live view image displayed in step S60.

On the contrary, if NO, the process advances to step S62 to continue the subsequent operation in the image-taking mode. In step S62, whether the user touches the shutter button 9 to set the state S1 or not is determined. If YES, processes in steps S63 and S64 are performed.

As already described, in the state S1, the image-taking preparing operations such as the auto-focus control (AF), auto exposure control (AE), and white balance control (WB) are performed (step S64). As the CCD reading mode, the octuple-speed mode and the AF mode are alternately repeated. In order to change the video format of the display device 2 to 525i (or 525p) prior to the image-taking preparing operations, the resolution switching signal is generated and transmitted to the display device 2 (step S63). The display resolution of the display device 2 is thereby changed to low resolution and the image data for display corresponding to the video format is transmitted.

After that, the overall control unit 30 moves to the image-taking preparing operation (step S64) and executes the auto-focus control (AF), auto exposure control (AE), white balance control (WB), and the like. The concrete operations are similar to the above-described ones.

Subsequently, when the user performs an operation of fully depressing the shutter button 9 to shift the digital camera into the state S2, step S65 is determined as YES, and step S66 follows.

In the state S2, by performing the operation of taking an image for recording, a recording process for recording the taken image into the memory card 90 is executed (step S66).

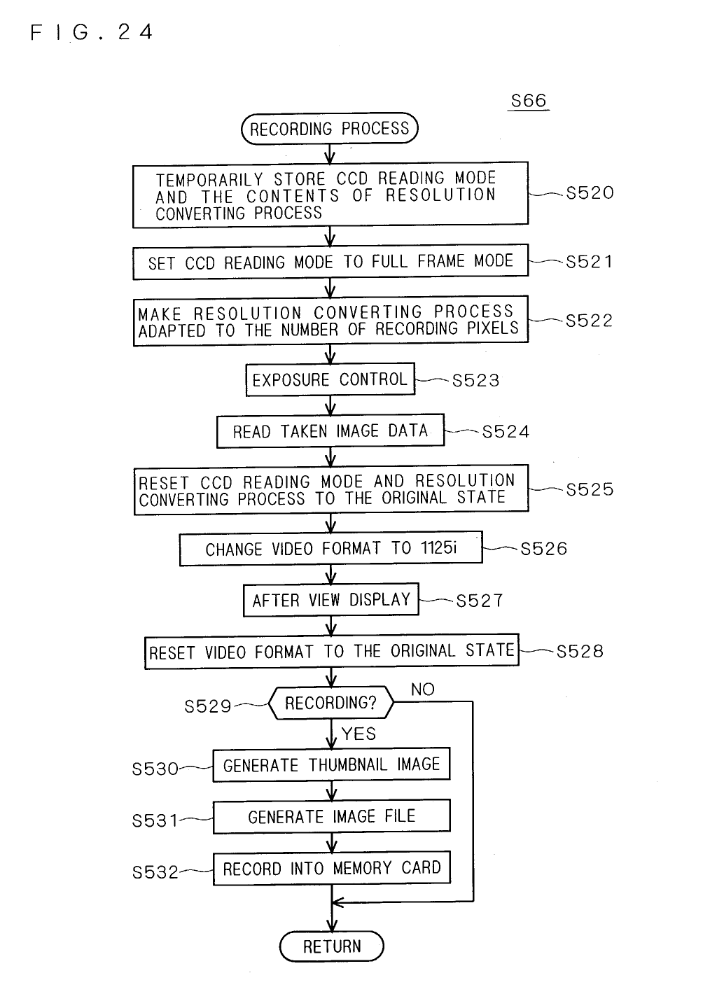

FIG. 24 is a flowchart showing the details of the recording process. When the recording process is started, first, the overall control unit 30 temporarily stores the present CCD reading mode and the contents of the resolution converting process (step S520). The overall control unit 30 changes the CCD reading mode to the full frame mode (step S521) and determines the contents of the resolution converting process so as to be adapted to the recording resolution (the number of recording pixels) which is set by the user (step S522).

After executing the exposure control (step S523), the taken image data is read from the CCD image capturing device 20 (step S524). At this time, in the resolution converting unit 26, the resolution converting process determined in step S522 is performed and taken image data obtained as a result is temporarily stored in the image memory 44.

When the image-taking operation is finished, the overall control unit 30 resets the CCD reading mode and the resolution converting process to the state stored in step S520 (step S525).

The overall control unit 30 generates the resolution switching signal to change the video format of the display device 2 to 1125i (or 1125p) to enable the taken image to be displayed with high definition on the display device 2 prior to the after view display and transmits it to the display device 2, thereby changing the display resolution of the display device 2 to high resolution and transmitting the image data for display adapted to the video format (step S526).

After that, the after view display based on the taken image is performed with high resolution on the display device 2 (step S527). Consequently, the user can easily recognize the detailed state of the taken image.

When the after view display is finished, in order to reset the display resolution of the display device 2 to the original state, the overall control unit 30 generates the resolution switching signal and transmits it to the display device 2 (step S528).

In step S529, whether the taken image data stored in the image memory 44 is recorded or not is determined. If YES, the overall control unit 30 generates a thumbnail image of the taken image (step S530). At this time, the thumbnail image is generated so as to be adapted to the display resolution of the EVF 4 and LCD 5. That is, the thumbnail image is an image consisting of 320 pixels in the horizontal direction and 240 pixels in the vertical direction.

The image file to be recorded to the memory card 90 is generated (step S531) and the process of recording the image file to the memory card 90 is performed (step S532).

In such a manner, the recording process is performed. As shown in FIG. 22, after the recording process (step S66) is finished, to enable the following image-taking operation to be performed, the overall control unit 30 returns to step S60.

As described above, the digital camera 1 is constructed to generate a signal for changing the display resolution of the display device 2 in accordance with the operation input by the user or the internal operation state of the digital camera 1, and to output the signal to the display device 2. Thus, the display resolution of the display device 2 can be changed from the camera 1 side. In the case of changing the display resolution of the display device 2 from the digital camera 1, the image data for display is generated so as to be adapted to the display resolution after the change and is outputted to the display device 2. Consequently, the image can be displayed on the display device 2 in an optimum state.

Particularly, by lowering the display resolution of the display device 2 in response to the shift to the image-taking preparing operation, the frame rate can be increased. Therefore, the user can perform the image-taking operation without missing a chance to take a good picture.

By lowing the display resolution of the display device 2 in response to the shift to the auto-focus operation, the load in the auto-focus operation can be lessened. Thus, the AF operation can be efficiently performed.

By increasing the display resolution of the display device 2 in the case where the focus state of the subject's image has to be determined (focus checking mode), the focus state of the subject's image can be accurately determined.

At the time of performing the after view display after the image-taking operation on the display device 2, by increasing the display resolution of the display device 2, the user can accurately recognize the details of an image taken.

When the luminance of the subject is lower than predetermined luminance, by lowering the display resolution of the display device 2, the pixel adding process for solving the low luminance state can be performed. Thus, the motion or the like of the subject can be easily recognized even in a dark place.

3-3. Process in Moving Image Recording Mode

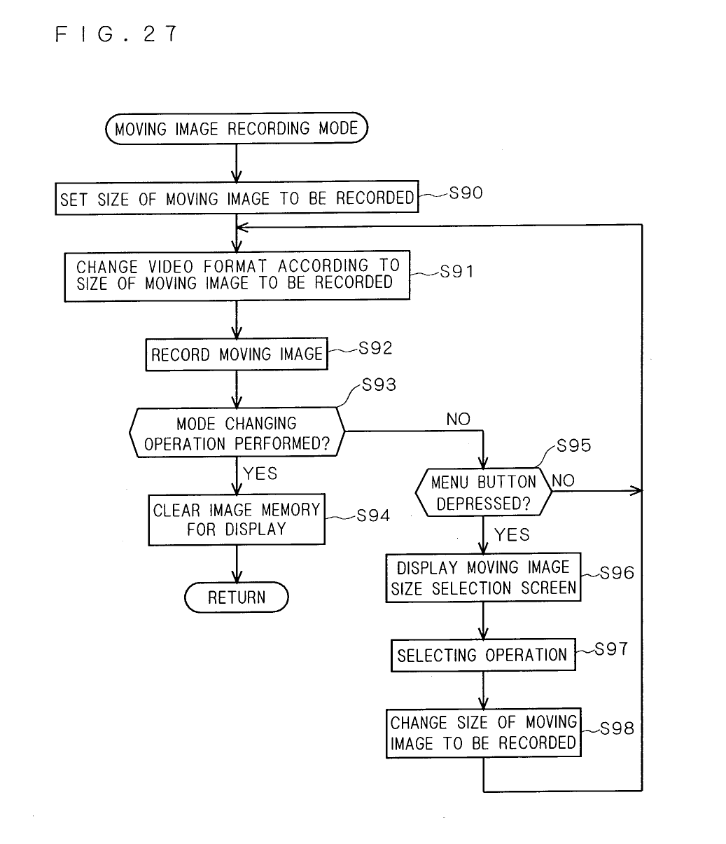

The process in the moving image recording mode will now be described. The digital camera 1 can select the size of a moving image at the time of recording a moving image. For example, a moving image size selection screen P1 as shown in FIG. 26 is displayed on the LCD 5 or the like and the user operates the control button 7 or the like, thereby enabling the image size at the time of recording a moving image to be selected. FIG. 26 shows a state where the size of a moving image of 640×480 is selected.

As shown in FIG. 26, in the case where the size of a moving image is 160×120, 320×240 and 640×480, the frame rate of the moving image to be recorded is 30 fps. When the size of a moving image is 960×720, the frame rate is 7.5 fps. Further, when the size of a moving image is 1,440×1,080, the frame rate is 3.8 fps.

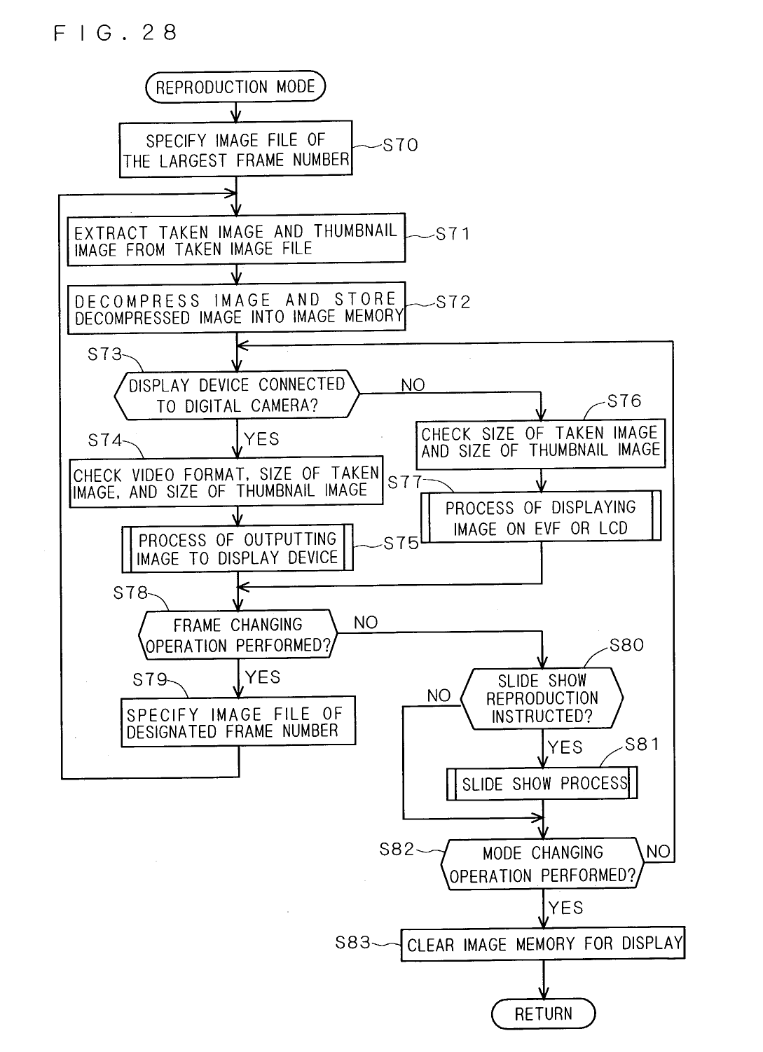

FIG. 27 is a flowchart showing the operation in the moving image recording mode. At the start of the moving image recording mode, while referring to the moving image size selection screen P1, the user preliminarily sets the recording size of a moving image (step S90). On the basis of the size of the moving image to be recorded which is designated by the user, the overall control unit 30 changes the video format of the display device 2 (step S91). In the ROM 30b of the overall control unit 30, table data as shown in Table 1 is stored. By referring to the table data, the overall control unit 30 specifies the video format (display resolution) adapted to the size of the moving image.

TABLE 1

| Size of moving image | Video format |
|---|---|
| 160 × 120 | 525i (or 525p) |
| 320 × 240 | |
| 640 × 480 | |
| 960 × 720 | 750p |
| 1440 × 1080 | 1125i (or 1125p) |

For example, when the size of the moving image of 640×480 is selected as shown in FIG. 26, a resolution switching signal for changing the video format of the display device 2 to 525i (or 525p) is generated and transmitted to the display device 2, thereby changing the display resolution of the display device 2. The CCD reading mode is changed to the octuple-speed mode and, after that, the image data for display corresponding to the video format is transmitted.

The moving image recording with the size of the moving image which is set in the digital camera 1 is started (step S92). For example, while the user continues the operation of fully depressing the shutter button 9 (state S2), the moving image recording is performed. Moving images taken are sequentially recorded on the memory card 90 and images for display are sequentially updated, thereby displaying the moving image being taken on the display device 2 like the live view display.

After the moving image recording is finished, whether the mode changing operation has been performed by the user or not is determined (step S93). If NO, the process advances to step S95. If YES, the overall control unit 30 clears the image memory 43 for display to erase the display state of the image (step S94) and finishes the moving image recording mode.

If NO in step S93, the overall control unit 30 determines whether the menu button 6 is depressed or not (step S95). If the menu button 6 is depressed, to change the recording size of the moving image, the overall control unit 30 displays the moving image size selection screen P1 on the EVF 4 or LCD 5 (step S96). The user selects one of the plurality of recording sizes by operating the control button 7 (step S97) and the overall control unit 30 changes the recording size of the moving image (step S98). The overall control unit 30 returns to step S91 and repeats the moving image recording operation.

As described above, at the time of recording the moving image, the display resolution of the display device 2 is set according to the recording size of the moving image, and the moving image being taken is displayed on the display device 2.

3-4. Process in Reproduction Mode

The process of the reproduction mode will now be described. FIGS. 28 to 30 are flowcharts showing the processing sequence of the digital camera 1 in the reproduction mode.

In the reproduction mode, the overall control unit 30 accesses the memory card 90 and specifies an image file of the largest frame number from image files stored in the memory card 90 (step S70) and extracts the taken image and the thumbnail image included in the specified image file (step S71). The overall control unit 30 performs a decompressing process on the extracted taken image and thumbnail image and stores the resultant images into the image memory 44 (step S72).

The overall control unit 30 determines whether the display device 2 is connected to the digital camera 1 or not (step S73), if YES, the process advances to step S74 and, if NO, the process advances to step S76.

When the display device 2 is connected to the digital camera 1, the overall control unit 30 checks the video format (display resolution) of the display device 2 and the size of the taken image and the size of the thumbnail image stored in the image memory 44 (step S74). The process of outputting the images to the display device 2 is executed (step S75).

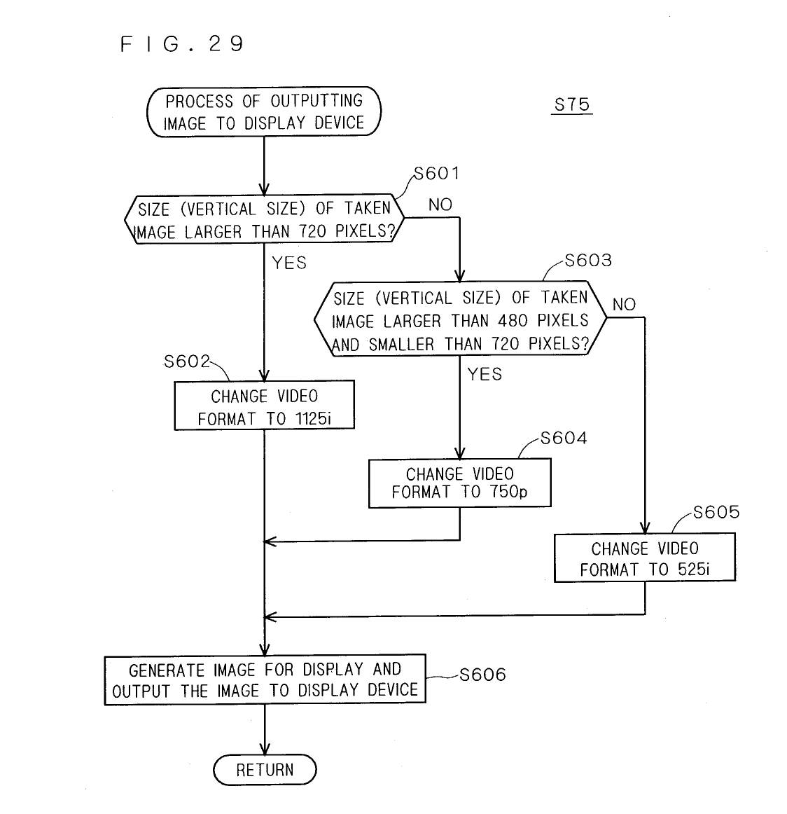

FIG. 29 is a flowchart showing the detailed process of step S75. First, the overall control unit 30 determines whether the size in the vertical direction of the taken image is larger than 720 pixels or not (step S601). If YES, to enable the taken image to be displayed with high definition on the display device 2, the overall control unit 30 generates the resolution switching signal for changing the video format of the display device 2 to 1125i (or 1125p) and transmits the signal to the display device 2, thereby changing the display resolution of the display device 2 to high resolution (step S602).

If NO in step S601, whether the size in the vertical direction of the taken image is larger than 480 pixels and smaller than 720 pixels is determined (step S603). In the case where the size in the vertical direction of the taken image is larger than 480 pixels and smaller than 720 pixels, the overall control unit 30 generates a resolution switching signal for changing the video format of the display device 2 to 750p and transmits the signal to the display device 2, thereby changing the display resolution of the display device 2 (step S604).

If NO in step S603, since the size in the vertical direction of the taken image is smaller than 480 pixels, the overall control unit 30 generates a resolution switching signal for changing the video format of the display device 2 to 525i (or 525p) and transmits it to the display device 2, thereby changing the display resolution of the display device 2 to low resolution (step S605).

After performing the resolution conversion of the display device 2 in accordance with the taken image size in steps S602, S604, and S605, a process for generating an image for display adapted to the video format and outputting the image to the display device 2 is performed (step S606).

On the other hand, when the display device is not connected to the digital camera 1 in step S73 in FIG. 28 (in the case of NO), the overall control unit 30 checks the size of the taken image and the size of the thumbnail image stored in the image memory 44 (step S76). After that, a display process on the EVF 4 or LCD 5 is executed (step S77). The details of the process in step S77 are similar to those in the flowchart of FIG. 16.

In step S78, the overall control unit 30 determines whether a frame feeding operation or frame rewinding operation has been performed by the user or not. If YES, the overall control unit 30 specifies an image file of a designated frame number (step S79) and returns to step S71.

In the case where there is no frame changing operation by the user, whether a slide show reproduction instruction has been given by the user or not is determined (step S80). If YES, the overall control unit 30 shifts to a slide show process (step S81).

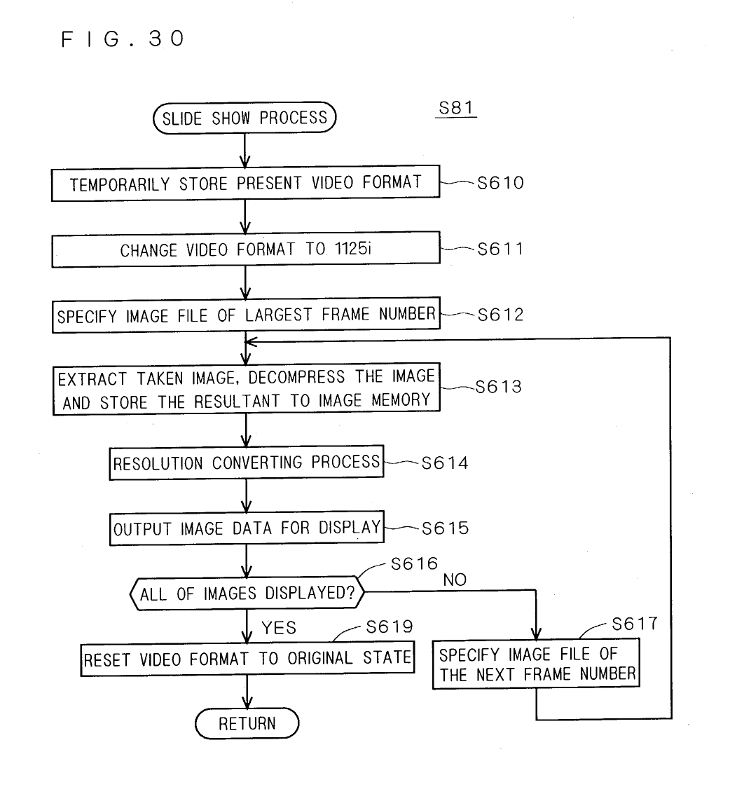

FIG. 30 is a flowchart showing the details of the slide show process. The overall control unit 30 temporarily stores the present video format (step S610), after that, generates a resolution switching signal for changing the video format to 1125i (or 1125p), and transmits the signal to the display device 2, thereby changing the display resolution of the display device 2 to high resolution (step S611).

The overall control unit 30 accesses the memory card 90 and specifies an image file of the largest frame number (step S612). The overall control unit 30 extracts a taken image from the specified image file, decompresses it, and stores the resultant image into the image memory 44 (step S613). The overall control unit 30 performs a resolution converting process so as to be adapted to 1,080 lines as the total number of vertical lines of the video format 1125i (step S614). That is, even in the case where the size of the taken image is smaller than 1440×1080, by performing the enlarging process, the image data for display adapted to the video format of 1125i is generated. The image data for display generated as a result is stored into the image memory 43 for display.

The image data for display is outputted to the display device 2 (step S615) and a reproduced image based on the taken image is displayed at high resolution on the display device 2.

Whether all of the images recorded on the memory card 90 are displayed or not is determined (step S616). If NO, the image file of the next frame number is specified (step S617) and the process of step S613 and subsequent processes are repeatedly executed.

If YES, the video format is reset to the original state stored in step S610 and the slide show process is finished.

Referring again to FIG. 28, after the slide show process is finished, whether the mode changing operation is performed or not is determined (step S82). If NO, the overall control unit 30 returns to step S73 and repeats similar processes. On the contrary, if YES, the image memory 43 for display is cleared to erase the reproduction and display state of the image (step S83), and finishes the reproduction mode.

In such a reproduction mode, at the time of reproducing and displaying an image, the display resolution of the display device 2 is changed according to the size of the image to be reproduced. Thus, the image to be reproduced can be displayed at high definition in the optimum state.

In the case of performing the slide show reproduction, the display resolution of the display device 2 can be increased. Therefore, a reproduced image used for a slide show can be recognized with high resolution.

In many cases, the display updating interval of slide show reproduction is generally a few seconds or longer, and a high frame rate is not required. On the other hand, when the video format is updated every image in accordance with the size of a taken image, flicker occurs in the screen. Consequently, by preliminarily increasing the display resolution of the display device 2 prior to outputting of image data for display which is used for slide show reproduction, occurrence of flicker in a display image during a slide show can be prevented. Since the frame rate can be decreased, a heavy load due to the enlarging process is not applied.

Further, after completion of the slide show reproduction, the display resolution of the display device 2 is reset to the original state before the slide show. Consequently, a reproduced image can be recognized at high resolution in the slide show reproduction and, after completion of the slide show, the display state can be shifted to the optimum display state according to the state of the digital camera 1.

By changing the video format in accordance with the size of an image to be reproduced as described above, an effect which is particularly useful in the case of reproducing a moving image is displayed.

For example, in the case where the recording size of a moving image is equal to or smaller than the VGA size of 320×240 or the like, an image of low resolution of 320×240 can be interpolated to an image of high resolution of 1440×1080 or the like and the resultant image can be outputted. In this case, however, a load is applied to and time is required for the interpolating process, and there is the possibility that a frame drop of a moving image occurs. To be specific, although a moving image is recorded with 30 fps, a reproduction speed may decrease to about 8 fps.

Consequently, when the recording size of a moving image is low resolution of VGA size of 320×240 or the like or lower, at the time of reproducing and displaying a moving image, by changing the video format of the display device 2 to low resolution of 525i or the like, the moving image can be outputted without performing an interpolating process. Thus, deterioration in the frame rate at the time of display can be prevented.

3-5. Process in Setting Mode

The process in a setting mode will now be described. As the number of functions of a digital camera increases in recent years, the number of setting items in the digital camera 1 remarkably increases. When the user makes settings of the digital camera 1, a high frame rate is not required. Therefore, by displaying a setting screen on the display device 2, at the time of making settings of the digital camera 1, the video format is set to 1125i and a setting screen is displayed at high resolution.

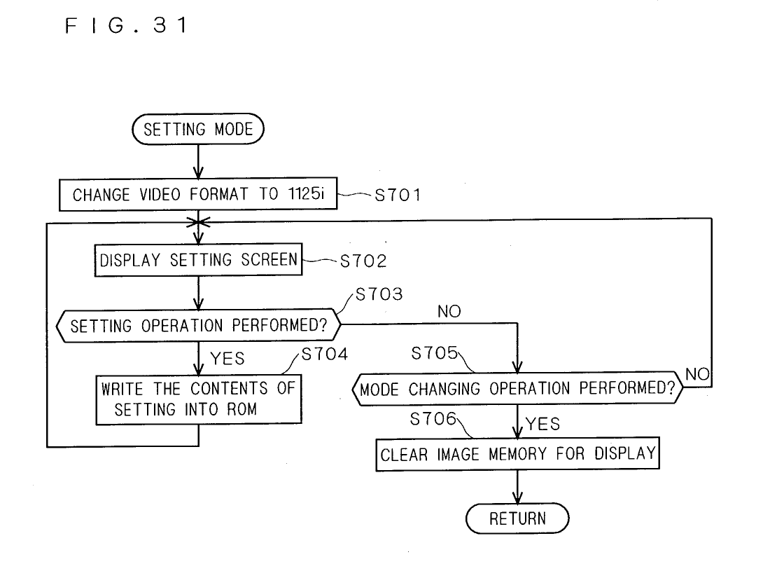

FIG. 31 is a flowchart showing the operation in the setting mode. In the setting mode, the overall control unit 30 generates a resolution switching signal for changing the video format to 1125i (or 1125p) and transmits the signal to the display device 2, thereby changing the display resolution of the display device 2 to high resolution (step S701).

The overall control unit 30 generates an image for the setting screen of high resolution corresponding to the video format of 1125i and outputs the image to the display device 2, thereby displaying the setting screen (step S702). Since the setting screen is displayed at high resolution, a number of items can be displayed in a screen so that the number of changes in the screen at the time of setting operation can be reduced.

The overall control unit 30 determines whether or not the setting operation has been performed by the user (step S703) and, if YES, writes the setting into the ROM 30b, thereby obtaining a state where the overall control unit 30 can operate on the basis of the setting (step S704). When the process of writing the setting into the ROM 30b is finished, the overall control unit 30 returns to step S702.

On the other hand, in the case where the setting operation is not performed, whether the mode setting operation is performed by the user or not is determined (step S705). If NO, the overall control unit 30 returns to step S702 and repeats similar processes. If YES, the overall control unit 30 clears the image memory 43 for display to erase the reproduction and display state of an image (step S83), and finishes the setting mode.

As described above, in the setting mode, by displaying a screen for setting at high resolution, a number of setting items can be displayed in one screen so that the operability at the time of setting is improved.

3-6. Process at the Time of Warning

The process at the time of warning will now be described. In the digital camera 1, in any of the cases such that the user performs an erroneous operation, the remaining capacity of the memory card 90 is reduced, and the battery is decreased, a warning is displayed. In the case where the display device 2 is connected to the digital camera 1 at this time, a warning is displayed also on the display device 2.

At the time of displaying a warning on the display device 2, the digital camera 1 does not output a signal for changing the display resolution of the display device 2. That is, warning display is performed while maintaining the display resolution. At the time of warning display, it is unnecessary to change the video format, and the necessity is low. Therefore, by performing the warning display without changing the display resolution, a useless process can be prevented and a warning can be displayed promptly.

4. Modifications

Although the embodiments of the present invention have been described above, the present invention is not limited to the above description.

For instance, the above description has illustrated the case where the five kinds of video formats of 525i, 525p, 750p, 1125i and 1125p are adapted to the display device 2, however, the video format is not limited to these five kinds. Other kinds of video formats may be selected in the above-described processes so as to be adapted to the display resolution of the display device.

According to the foregoing preferred embodiments, the display resolution of a display device is detected and a method of reading the image capturing device is changed according to the display resolution. Consequently, an image can be captured from the image capturing device so as to be adapted to the display resolution of the display device and a high-precision image can be displayed by utilizing the display resolution of the display device.

When an external display device is connected to the digital camera, image data for display is generated so as to be adapted to the display resolution of the external display device and a thumbnail image is generated so as to be adapted to the display resolution of a display unit built in the digital camera. At the time of displaying an image on the built-in display unit; therefore, the image can be displayed by using the thumbnail image. Consequently, a process of enlarging or reducing the image is unnecessary and the image can be displayed efficiently.

When the external display device is connected to the digital camera, image data for after view display is generated so as to be adapted to display resolution of the external display device. Consequently, since the after view display is performed in a state where the display resolution of the external display unit is maximally utilized, the state of the details of an image can be easily recognized.

When the external display device is connected to the digital camera, either the taken image or the thumbnail image is selected as an image to be reproduced on the basis of the display resolution from the external display device and the image data for display is generated. Thus, while lessening the processing load at the time of reproduction and display, an image can be reproduced and displayed at the optimum resolution.

Further, the display resolution of the external display device is changed according to an operation input by the user or an operating state of the digital camera. In this case, the image data for display is generated so as to be adapted to the changed display resolution and is outputted to the external display device. Therefore, optimum image display can be always performed.

While the invention has been shown and described in detail, the foregoing description is in all aspects illustrative and not restrictive. It is therefore understood that numerous modifications and variations can be devised without departing from the scope of the invention.

What is claimed is:

1. A digital camera comprising:
a detector for detecting a display condition of a display unit for performing display;
a controller for controlling said digital camera; and
a control changing unit for changing a control operation performed by said controller in accordance with a detection signal of said detector.

2. The digital camera according to claim 1, wherein
said display unit is a display unit externally connected to said digital camera.

3. The digital camera according to claim 2, wherein
said display condition is a display resolution of said display unit.

4. The digital camera according to claim 3, wherein
said controller changes resolution of image data for display which is outputted to said display unit in accordance with said display resolution.

5. A digital camera which can be connected to an external display unit, comprising:
a detector for detecting display resolution of said external display unit for performing display;
a data processor for generating image data to be displayed on said external display unit; and
a process changing unit for changing a process to be performed by said data processor in accordance with display resolution of said external display unit detected by said detector.

6. The digital camera according to claim 5, wherein
said data processor changes resolution of image data for display which is outputted to said external display unit in accordance with display resolution of said external display unit.

7. The digital camera according to claim 5, further comprising:
an image capturing device for generating image data by an image-taking operation, wherein
said data processor generates image data adapted to display resolution of said external display unit by changing a method of reading image data from said image capturing device in accordance with display resolution of said external display unit.

8. The digital camera according to claim 7, wherein
as the display resolution of said external display unit increases, said data processor decreases a display frame rate and a rate of reading image data from said image capturing device.

9. The digital camera according to claim 5, further comprising:
an image capturing device for generating image data by an image-taking operation, wherein
said data processor executes a resolution converting process on image data obtained from said image capturing device in accordance with display resolution of said external display unit, thereby generating image data adapted to display resolution of said external display unit.

10. The digital camera according to claim 5, further comprising:
a built-in display unit provided integrally with said digital camera, wherein
said data processor generates data to be displayed on said built-in display unit when said external display unit is not connected.

11. The digital camera according to claim 10, wherein
said data processor is constructed so as to generate an image for recording and a thumbnail image for said image for recording at the time of an image-taking operation, and said thumbnail image is so generated as to be adapted to display in said built-in display unit.

12. The digital camera according to claim 5, wherein
said data processor generates image data for after view display in accordance with display resolution of said external display unit after the image-taking operation in order to display an image obtained by image-taking.

13. The digital camera according to claim 5, wherein
said data processor operates to generate and record an image for recording and a thumbnail image of said image for recording at the time of the image-taking operation, and selects an image to be reproduced from said image for recording and said thumbnail image in accordance with display resolution of said external display unit at the time of a recording image reproducing operation.

14. The digital camera according to claim 13, wherein
said data processor selects said image to be reproduced so as to be adapted to the display resolution of said external display unit on the basis of the size of said image for recording and the size of said thumbnail image.

15. The digital camera according to claim 13, further comprising:
an image memory for storing said image for recording and said thumbnail image, wherein
said data processor selects said image to be reproduced from said image memory on the basis of display resolution of said external display unit.

16. The digital camera according to claim 13, wherein
said data processor selects said image to be reproduced and performs a resolution converting process on said image to be reproduced so as to be adapted to the display resolution of said external display unit.

17. The digital camera according to claim 5, further comprising:
a resolution changing unit for changing display resolution of said external display unit, wherein
said data processor generates image data for display so as to be adapted to display resolution changed by said resolution changing unit.

18. The digital camera according to claim 17, wherein
when it is necessary to check a focus state of an image of a subject, said resolution changing unit outputs a signal for increasing the display resolution of said external display unit to said external display unit.

19. The digital camera according to claim 17, wherein
at the time of taking a moving image, said resolution changing unit outputs a signal for changing display resolution of said external display unit to said external display unit in accordance with the size of a moving image.

20. The digital camera according to claim 17, wherein
at the time of reproducing and displaying an image, said resolution changing unit outputs a signal for changing display resolution of said external display unit to said external display unit in accordance with the size of an image to be reproduced.

21. An image display system in which a digital camera and a display unit are connected to each other, wherein
said display unit has predetermined display resolution and displays an image inputted from said digital camera, and
said digital camera comprises:
a detector for detecting display resolution of said display unit;
a data processor for generating image data to be displayed on said display unit; and
a process changing unit for changing a process to be performed by said data processor on the basis of display resolution of said display unit detected by said detector.

22. The image display system according to claim 21, wherein
said data processor changes resolution of image data for display which is outputted to said display unit in accordance with display resolution of said display unit.
